(19) United States
(12) Patent Application Publication
(10) Pub. No.: US 2026/0320315 A1
(43) Pub. Date: Oct. 15, 2026

(54) WEARABLE DEVICE, TWO-WAY LANGUAGE TRANSLATION METHOD, AND TWO-WAY TRANSLATION SYSTEM

(71) Applicant: THINKAR PTE. LTD., Singapore (SG)

(72) Inventors: Zhou Ye, Taipei City (TW); Feng Wu, Taipei City (TW)

(73) Assignee: THINKAR PTE. LTD., Singapore (SG)

(21) Appl. No.: 19/466,489

(22) Filed: Feb. 1, 2026

Related U.S. Application Data
(60) Provisional application No. 63/760,121, filed on Feb. 19, 2025.
(60) Provisional application No. 63/807,860, filed on May 18, 2025.

(51) Int. Cl. G06F 40/58; G10L 21/02; H04R 1/02; H04R 1/08

(52) U.S. Cl. CPC G06F 40/58; G10L 21/02; H04R 1/025; H04R 1/08

(57) ABSTRACT

The present disclosure provides a wearable device, a two-way language translation method, and a two-way translation system. The wearable device is configured to be worn by a local user. One or more microphones of the wearable device capture a first voice from the local user and a second voice from a target user. A processor of the wearable device executes a translation program to obtain a first translated content corresponding to the first voice and obtain a second translated content corresponding to the second voice. The first translated content corresponds to a second language of the second voice, and the second translated content corresponds to a first language of the first voice. One or more speakers of the wearable device output the second translated content to the local user and output the first translated content to the target user. Thereby, the wearable device facilitates two-way communication between the local user and the target user.

### CROSS-REFERENCE TO RELATED APPLICATION

This application claims the priority benefits of U.S. provisional application Ser. No. 63/760,121, filed on Feb. 19, 2025 and U.S. provisional application Ser. No. 63/807,860, filed on May 18, 2025. The entirety of each of the above-mentioned patent applications is hereby incorporated by reference herein and made a part of this specification.

### BACKGROUND

### Technical Field

The present disclosure relates to translation technology, and more particularly, to a wearable device, a two-way language translation method, and a two-way translation system for performing real-time two-way language translation.

### Description of Related Art

Existing wearable devices, such as smart glasses, often include translation features. These devices typically capture the voice of a person speaking to the user, translate the voice into the user's language, and present the translated content to the user. This enables the user to understand the content spoken by the person.

However, these existing wearable devices often lack a reciprocal translation mechanism. Specifically, the person cannot understand the user's language unless the person also wears a device with translation features. Consequently, existing technologies only achieve one-way understanding and fail to achieve effective two-way communication.

### SUMMARY

In view of this, to solve the problem in the prior art where the lack of a reciprocal translation mechanism leads to an inability to conduct effective two-way communication, the present disclosure provides a wearable device, a two-way language translation method, and a two-way translation system. The wearable device of the present disclosure is configured with a speaker arrangement capable of outputting corresponding translated content to a local user and a target user respectively, thereby establishing a two-way communication channel.

One or more embodiment of the disclosure provides a wearable device for two-way language translation, wherein the wearable device is configured to be worn by a local user, the wearable device comprising: one or more microphones, configured to capture a first voice from the local user and a second voice from a target user, wherein a language of the first voice is different from a language of the second voice; a storage device storing a translation program; a processor coupled to the one or more microphones and the storage device, wherein the processor executes the translation program to obtain a first translated content corresponding to the first voice and obtain a second translated content corresponding to the second voice, wherein the first translated content corresponds to the second language of the second voice, and the second translated content corresponds to the first language of the first voice; and one or more speakers, coupled to the processor and configured to: output the second translated content to the local user; and output the first translated content to the target user.

One or more embodiment of the disclosure provides a two-way language translation method applied to a wearable device, the method comprising: capturing a first voice from a local user and a second voice from a target user; obtaining a first translated content corresponding to the first voice and obtaining a second translated content corresponding to the second voice, wherein the first translated content corresponds to a second language of the second voice, and the second translated content corresponds to a first language of the first voice; outputting the second translated content to the local user; and outputting the first translated content to the target user.

One or more embodiment of the disclosure provides a two-way translation system, comprising: a wearable device, configured to be worn by a local user; an external device; and a communication link established between the wearable device and the external device; wherein the wearable device captures a first voice from the local user and a second voice from a target user, wherein a language of the first voice is different from a language of the second voice; wherein the wearable device transmits the first voice and the second voice to the external device via the communication link; wherein the external device executes a translation program to obtain a first translated content corresponding to the first voice and to obtain a second translated content corresponding to the second voice, wherein the first translated content corresponds to a second language of the second voice, and the second translated content corresponds to a first language of the first voice; wherein the external device transmits the first translated content and the second translated content to the wearable device via the communication link; and wherein the wearable device outputs the second translated content to the local user and outputs the first translated content to the target user.

One or more embodiment of the disclosure provides a translation device for a wearable device, the translation device comprising: a housing configured to be detachably coupled to the wearable device; a connector disposed on the housing, configured to establish an electrical connection with the wearable device for receiving a first voice signal from the wearable device, wherein the first voice signal corresponds to a voice of a local user; a processor disposed within the housing; a memory coupled to the processor, wherein the memory stores a translation program; and a speaker disposed within the housing and coupled to the processor; wherein the processor executes the translation program to translate the first voice signal and generate a first translated content, and the speaker outputs the first translated content to a target user.

Based on the above, the wearable device, the two-way language translation method, and the two-way translation system provided by the present disclosure capture the first voice from the local user and the second voice from the target user via the one or more microphones, enabling the processor to obtain voice inputs from both parties. Subsequently, the processor executes the translation program to respectively generate the first translated content corresponding to the second language and the second translated content corresponding to the first language, ensuring that the semantics of both parties are converted into languages understandable to each other. Finally, the one or more speakers output the second translated content to the local user and output the first translated content to the target user, respectively. This configuration allows the target user to hear the translated voice of the local user without wearing an additional translation device, thereby facilitating real-time two-way interaction between the local user and the target user.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating a usage scenario of a wearable device for two-way translation according to an embodiment of the present disclosure.

FIG. 2 is a block diagram illustrating a hardware architecture of the wearable device according to an embodiment of the present disclosure.

FIG. 3A is a block diagram illustrating a two-way translation system including the wearable device and an external device according to an embodiment of the present disclosure.

FIG. 3B is a block diagram illustrating a two-way translation system including the wearable device and a server according to another embodiment of the present disclosure.

FIG. 4 is a schematic diagram illustrating the wearable device implemented as smart glasses according to an embodiment of the present disclosure.

FIG. 5 is a schematic diagram illustrating an integrated second speaker of the wearable device according to an embodiment of the present disclosure.

FIG. 6 is a schematic diagram illustrating a second speaker connected to the wearable device via a connecting part according to an embodiment of the present disclosure.

FIG. 7 is a schematic diagram illustrating an integrated second speaker disposed at a hinge of smart glasses according to an embodiment of the present disclosure.

FIG. 8A is a perspective view illustrating an attachable speaker module attached to the wearable device according to an embodiment of the present disclosure.

FIG. 8B is a perspective view illustrating the attachable speaker module detached from the wearable device according to the embodiment of FIG. 8A.

FIG. 8C is a block diagram illustrating a hardware architecture of the wearable device and the attachable speaker module configured as a translation device according to an embodiment of the present disclosure.

FIG. 8D is a flowchart illustrating an operation process performed by the attachable speaker module in FIG. 8C according to an embodiment of the present disclosure.

FIG. 9 is an enlarged schematic diagram illustrating an attachable speaker module and a connector according to an embodiment of the present disclosure.

FIG. 10 is a schematic diagram illustrating a connector with an enlarged detail view according to an embodiment of the present disclosure.

FIG. 11 is a sequence diagram illustrating a two-way translation process according to an embodiment of the present disclosure.

FIG. 12 is a sequence diagram illustrating a two-way translation process involving a detachable speaker module and intelligent algorithms according to an embodiment of the present disclosure.

FIG. 13 is a flowchart illustrating a two-way language translation method according to an embodiment of the present disclosure.

FIG. 14 is a flowchart diagram illustrating an intonation simulation algorithm according to an embodiment of the present disclosure.

### DESCRIPTION OF THE EMBODIMENTS

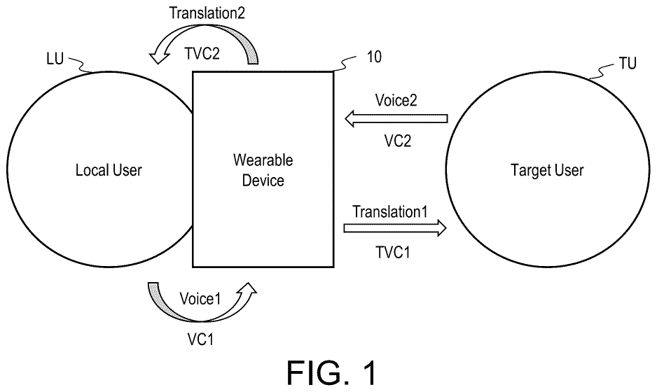

FIG. 1 is a schematic diagram illustrating a usage scenario of a wearable device 10 for two-way translation according to an embodiment of the present disclosure. As shown in FIG. 1, a local user LU wears the wearable device 10 and communicates with a target user TU who does not wear any translation device.

In an embodiment, the local user LU speaks a first voice VC1 in a first language, and the wearable device 10 captures the first voice VC1. The wearable device 10 translates the first voice VC1 into a first translated content TVC1 corresponding to a second language of the target user TU. The wearable device 10 then outputs the first translated content TVC1 to the target user TU, enabling the target user TU to understand what the local user LU has spoken.

In an embodiment, the target user TU speaks a second voice VC2 in the second language, and the wearable device 10 captures the second voice VC2. The wearable device 10 translates the second voice VC2 into a second translated content TVC2 corresponding to the first language of the local user LU. The wearable device 10 then outputs the second translated content TVC2 to the local user LU, enabling the local user LU to understand what the target user TU has spoken.

Accordingly, the wearable device 10 of the present disclosure enables two-way translation between the local user LU and the target user TU, wherein only the local user LU needs to wear the wearable device 10. The target user TU does not need to wear any translation device to communicate with the local user LU through the wearable device 10.

In an embodiment, the first translated content TVC1 is in the form of audio. The wearable device 10 may further apply an intonation simulation algorithm to the first translated content TVC1, such that the first translated content TVC1 carries acoustic characteristics of the local user LU, including at least one of voice tone, pitch variation, and volume variation. Accordingly, the target user TU hears the first translated content TVC1 with a voice tone similar to that of the local user LU, thereby facilitating a more natural communication experience.

In an embodiment, the second translated content TVC2 may be in the form of audio, text, or both. When the second translated content TVC2 is in the form of audio, the wearable device 10 outputs the second translated content TVC2 through a first speaker to the local user LU. When the second translated content TVC2 is in the form of text, the wearable device 10 displays the second translated content TVC2 on a display of the wearable device 10, such as a lens of smart glasses or an augmented reality (AR) display, enabling the local user LU to read the translated content.

In an embodiment, the translation function of the wearable device 10 may be triggered by the local user LU through a manual operation, such as pressing a button, issuing a voice command, or performing a gesture. Alternatively, the wearable device 10 may automatically trigger the translation function. Specifically, the wearable device 10 identifies a language of the local user LU and a language of the target user TU based on captured voice signals. When the wearable device 10 determines that the language of the local user LU is different from the language of the target user TU, the wearable device 10 automatically enables the translation function to translate the voices between the local user LU and the target user TU.

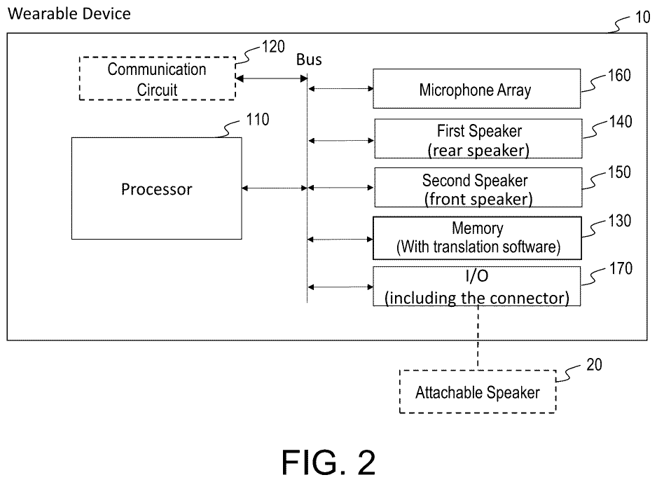

Referring to FIG. 2, in an embodiment, the wearable device 10 includes a processor 110, a memory 130, a microphone array 160, a first speaker 140, a second speaker 150, and an input/output (I/O) interface 170. The processor 110 is coupled to the memory 130, the microphone array 160, the first speaker 140, the second speaker 150, and the I/O interface 170 through a bus. In some embodiments, the wearable device 10 further includes a communication circuit 120 coupled to the processor 110 through the bus. The communication circuit 120 is configured to communicate with an external device.

In an embodiment, the processor 110 is configured to execute a translation program stored in the memory 130 to perform the two-way language translation. The processor 110 may include one or more processing units, such as a central processing unit (CPU), a graphics processing unit (GPU), a neural processing unit (NPU), or a combination thereof. In some embodiments, the processor 110 includes a main application processor and one or more embedded processors, such as a microcontroller (MCU) or a digital signal processor (DSP). The main application processor executes the translation program, while the embedded processors handle audio signal processing tasks such as beamforming and noise suppression.

In an embodiment, the memory 130 (also referred to as storage device) is configured to store the translation program. The memory 130 may include volatile memory, non-volatile memory, or a combination thereof. For example, the volatile memory may include random access memory (RAM) such as dynamic RAM (DRAM) or static RAM (SRAM). The non-volatile memory may include read-only memory (ROM), flash memory, or a solid-state drive (SSD). In some embodiments, the memory 130 further stores a beamforming algorithm, an intonation simulation algorithm, a language identification algorithm, and voiceprint data of the local user LU.

In an embodiment, the processor 110 utilizes the voiceprint data stored in the memory 130 to distinguish the first voice VC1 from the local user LU and the second voice VC2 from the target user TU. Specifically, the processor 110 extracts acoustic features from audio signals captured by the microphone array 160. The acoustic features may include at least one of fundamental frequency, formant frequencies, spectral envelope, mel-frequency cepstral coefficients (MFCCs), pitch patterns, and speaking rate. The processor 110 compares the extracted acoustic features with the voiceprint data of the local user LU stored in the memory 130. When the extracted acoustic features match the voiceprint data of the local user LU within a predetermined similarity threshold, the processor 110 identifies the corresponding audio segment as the first voice VC1. When the extracted acoustic features do not match the voiceprint data of the local user LU, the processor 110 identifies the corresponding audio segment as the second voice VC2 from the target user TU. In some embodiments, the voiceprint data of the local user LU is captured and stored in the memory 130 during an initial setup phase or a user registration process, wherein the local user LU speaks one or more predetermined phrases or sentences, and the processor 110 extracts and stores the corresponding acoustic features as the voiceprint data.

In an embodiment, the processor 110 further utilizes the voiceprint data of the local user LU to enhance the signal quality of the second voice VC2 from the target user TU. Specifically, when the local user LU and the target user TU are speaking simultaneously, the audio signals captured by the microphone array 160 contain a mixture of the first voice VC1 and the second voice VC2. The processor 110 performs a voice separation operation on the mixed audio signals using the voiceprint data of the local user LU. The processor 110 identifies and subtracts voice components corresponding to the voiceprint data of the local user LU from the mixed audio signals, thereby obtaining a cleaner signal of the second voice VC2 with reduced interference from the first voice VC1. Accordingly, the translation quality for the second voice VC2 is improved even when the local user LU and the target user TU are speaking at the same time.

In an embodiment, the processor 110 further utilizes the separated second voice VC2 to enhance the beamforming performance of the microphone array 160. Specifically, after the processor 110 performs the voice separation operation to obtain the second voice VC2 with reduced interference from the first voice VC1, the processor 110 analyzes the separated second voice VC2 to extract acoustic characteristics of the target user TU. The acoustic characteristics may include fundamental frequency, formant frequencies, spectral envelope, pitch patterns, and other voice features that are unique to the target user TU. The processor 110 uses the extracted acoustic characteristics to generate a temporary voiceprint profile of the target user TU.

In an embodiment, the processor 110 utilizes the temporary voiceprint profile of the target user TU to refine the beamforming algorithm. Specifically, the processor 110 correlates the acoustic characteristics of the target user TU with the audio signals received from each microphone element of the microphone array 160 to more precisely determine a direction of arrival (DOA) of the second voice VC2. Based on the determined direction of arrival, the processor 110 adjusts beamforming parameters to steer a reception beam of the microphone array 160 toward the target user TU. By using the acoustic characteristics as a reference, the processor 110 can distinguish the second voice VC2 from environmental noise and other sound sources more accurately, thereby forming a narrower and more focused reception beam directed at the target user TU.

In an embodiment, the processor 110 performs an iterative optimization process to progressively improve the signal quality of the second voice VC2. In a first iteration, the processor 110 uses the voiceprint data of the local user LU to separate the first voice VC1 from the mixed audio signals, obtaining an initial estimate of the second voice VC2. The processor 110 extracts acoustic characteristics from the initial estimate and generates the temporary voiceprint profile of the target user TU. In subsequent iterations, the processor 110 uses both the voiceprint data of the local user LU and the temporary voiceprint profile of the target user TU to perform enhanced voice separation and beamforming. Specifically, the processor 110 adjusts the beamforming parameters to suppress audio components matching the voiceprint data of the local user LU while enhancing audio components matching the temporary voiceprint profile of the target user TU. This iterative process progressively improves the accuracy of the beamforming and the clarity of the separated second voice VC2, resulting in higher translation quality for the second voice VC2.

In an embodiment, the processor 110 dynamically updates the temporary voiceprint profile of the target user TU during the conversation. As the conversation progresses, the processor 110 continuously analyzes the separated second voice VC2 and refines the acoustic characteristics stored in the temporary voiceprint profile. This dynamic updating allows the processor 110 to adapt to variations in the voice of the target user TU caused by emotional changes, speaking volume adjustments, or environmental factors. In some embodiments, the processor 110 tracks movement of the target user TU by monitoring changes in the direction of arrival of the second voice VC2, and dynamically adjusts the beamforming parameters to maintain optimal reception of the second voice VC2 even when the target user TU moves during the conversation.

In an embodiment, the processor 110 utilizes the voiceprint data of the local user LU to enhance the intonation simulation for the first translated content TVC1. Specifically, the voiceprint data stored in the memory 130 includes detailed acoustic characteristics of the local user LU, such as characteristic pitch range, typical pitch variation patterns, habitual speaking rate, voice timbre, and volume dynamics. During an initial setup phase or a user registration process, the local user LU speaks one or more predetermined phrases or sentences, and the processor 110 extracts and stores the corresponding acoustic features as the voiceprint data. When executing the intonation simulation algorithm, the processor 110 retrieves the voiceprint data from the memory 130 and applies the stored acoustic characteristics to the first translated content TVC1. Since the voiceprint data is collected in advance and comprehensively represents the speaking style of the local user LU, the intonation simulation algorithm can more accurately reproduce the voice tone, pitch patterns, and speaking rhythm of the local user LU in the first translated content TVC1, thereby providing a more natural and personalized communication experience for the target user TU.

In an embodiment, the microphone array 160 includes a plurality of microphone elements pointing in different directions. The microphone array 160 is configured to capture the first voice VC1 from the local user LU and the second voice VC2 from the target user TU. The plurality of microphone elements may include micro-electro-mechanical system (MEMS) microphones, electret condenser microphones (ECMs), or a combination thereof.

In some embodiments, the microphone array 160 includes a first microphone array disposed closer to a mouth of the local user LU to capture the first voice VC1, and a second microphone array disposed farther from the mouth of the local user LU to capture the second voice VC2 or environmental noise. This spatial arrangement facilitates effective voice separation and noise suppression.

In an embodiment, the first speaker 140 is configured to output the second translated content TVC2 to the local user LU. As shown in FIG. 2, the first speaker 140 is also referred to as a rear speaker. The first speaker 140 is built into the wearable device 10 and may have a sound outlet facing the local user LU. For example, the first speaker 140 may include a dynamic speaker, a balanced armature speaker, a piezoelectric speaker, a bone conduction transducer, or a combination thereof. In some embodiments, the first speaker 140 adopts an open-ear acoustic structure and is configured to generate a directional sound field to direct the second translated content TVC2 to an ear of the local user LU and suppress sound leakage. In other embodiments, the first speaker 140 is implemented as a wired earphone or a wireless earphone connected to or integrated with the wearable device 10. For example, the wireless earphone may communicate with the processor 110 via a Bluetooth connection, and the processor 110 transmits the second translated content TVC2 to the wireless earphone for playback to the local user LU.

In an embodiment, the second speaker 150 is configured to output the first translated content TVC1 to the target user TU. As shown in FIG. 2, the second speaker 150 is also referred to as a front speaker. The second speaker 150 is built into the wearable device 10 and has a sound outlet facing a direction away from the local user LU. For example, the second speaker 150 may include a dynamic speaker, a balanced armature speaker, a piezoelectric speaker, or a combination thereof.

In an embodiment, the first speaker 140 further executes a bass enhancement algorithm to compensate for low-frequency loss caused by the open-ear acoustic structure. Specifically, open-ear speakers typically have reduced bass response compared to in-ear or over-ear speakers due to the lack of acoustic sealing. The bass enhancement algorithm analyzes the frequency content of the second translated content TVC2 and selectively amplifies low-frequency components to provide a fuller and more natural sound quality for the local user LU. In some embodiments, the bass enhancement algorithm applies dynamic equalization based on the ambient noise level, adjusting the bass amplification to maintain consistent audio quality in different environments.

In another embodiment, the second speaker 150 is physically implemented within the speaker module 20 (labeled as “Attachable Speaker” in FIG. 2). Although FIG. 2 illustrates the second speaker 150 as being included within the wearable device 10 for the purpose of illustrating the functional architecture of the system, it should be understood that in this embodiment, the second speaker 150 is physically located in the speaker module 20 rather than being fixed within the main body of the wearable device 10. The speaker module 20 is detachably coupled to the wearable device 10 via the I/O interface 170. When the speaker module 20 is attached to the wearable device 10, the speaker module 20 is electrically coupled to the wearable device 10 via a connector included in the I/O interface 170, allowing the second speaker 150 disposed therein to output the first translated content TVC1 to the target user TU. When there is no translation need, the local user LU may detach the speaker module 20 from the wearable device 10.

In some embodiments, the processor 110 is configured to detect an attachment status of the speaker module 20. Upon detecting that the speaker module 20 is attached to the wearable device 10, the processor 110 automatically enables a two-way translation function. Specifically, the processor 110 may start to identify language types of the first voice VC1 and the second voice VC2 in response to detecting the attachment of the speaker module 20. When the processor 110 determines that a language of the first voice VC1 is different from a language of the second voice VC2, the processor 110 executes the translation program to perform the two-way language translation. Accordingly, the two-way translation function is triggered by the attachment of the speaker module 20, without requiring additional manual operation by the local user LU.

In an embodiment, the translation program includes natural language processing (NLP) algorithms for understanding and generating human language, speech recognition algorithms for converting the first voice VC1 and the second voice VC2 into text, machine translation algorithms for translating text between the first language and the second language, and text-to-speech (TTS) algorithms for synthesizing the first translated content TVC1 and the second translated content TVC2 as audio.

In an embodiment, the I/O interface 170 includes the connector for electrically coupling the speaker module 20 to the wearable device 10. The I/O interface 170 may further include other input/output ports for power supply or data transmission. In some embodiments, the connector included in the I/O interface 170 comprises a plurality of pogo pins configured to transmit audio signals and power to the speaker module 20.

In some embodiment, the communication circuit 120 is configured to communicate with the external device. The communication circuit 120 may include a wired interface circuit, a wireless interface circuit, or a combination thereof. For example, the wireless interface circuit may include a Bluetooth transceiver, a Wi-Fi transceiver, a near-field communication (NFC) transceiver, or a cellular network transceiver. In some embodiments, the processor 110 transmits the first voice VC1 and the second voice VC2 to the external device via the communication circuit 120 for translation processing, and receives the first translated content TVC1 and the second translated content TVC2 from the external device.

Specifically, the communication circuit 120 establishes a communication link with the external device. The processor 110 transmits the captured voice signals to the external device via the communication link, and receives the translated audio signals from the external device via the same communication link.

In an embodiment, when the wearable device 10 receives the first translated content TVC1 and the second translated content TVC2 from the external device via the communication circuit 120, the processor 110 routes the received translated content to the corresponding speakers for output. Specifically, the processor 110 transmits the first translated content TVC1 to the second speaker 150 or the speaker module 20 for playback to the target user TU, and transmits the second translated content TVC2 to the first speaker 140 for playback to the local user LU. In some embodiments, the processor 110 further processes the received translated content before output, such as adjusting volume levels based on ambient noise detected by the microphone array 160, or applying audio equalization to optimize sound quality for the acoustic characteristics of the first speaker 140 and the second speaker 150.

In an embodiment, the external device may transmit the translated content to the wearable device 10 in different formats depending on system configuration and network conditions. In a first format, the external device transmits the first translated content TVC1 and the second translated content TVC2 as synthesized audio signals. The processor 110 of the wearable device 10 directly outputs the received audio signals through the corresponding speakers without additional processing. In a second format, the external device transmits the first translated content TVC1 and the second translated content TVC2 as translated text data. The processor 110 of the wearable device 10 executes a text-to-speech (TTS) algorithm stored in the memory 130 to convert the received translated text data into audio signals, and then outputs the converted audio signals through the corresponding speakers. The second format reduces the data bandwidth required for transmission between the external device and the wearable device 10, which may be advantageous in low-bandwidth network conditions. In a third format, the external device transmits both synthesized audio signals and corresponding text data. The processor 110 outputs the audio signals through the speakers and simultaneously displays the text data on a display of the wearable device 10, providing the local user LU with both audio and visual translation outputs.

In an embodiment, the wearable device 10 dynamically switches between the different formats based on network conditions, processing load, or user preferences. For example, when the communication link between the wearable device 10 and the external device has sufficient bandwidth and low latency, the processor 110 requests the external device to transmit synthesized audio signals (the first format) to minimize local processing load and leverage the superior text-to-speech synthesis capabilities of the external device. When the communication link has limited bandwidth or high latency, the processor 110 requests the external device to transmit translated text data (the second format), and performs text-to-speech conversion locally to reduce transmission delay. In some embodiments, the local user LU may configure a preferred format through a user interface of the wearable device 10 or a companion application running on the external device.

It should be noted that FIG. 2 illustrates the components related to the two-way language translation function. In some embodiments, when the wearable device 10 is implemented as smart glasses, the wearable device 10 may further include additional components not shown in FIG. 2. For example, the wearable device 10 may further include a display coupled to the processor 110, wherein the display is configured to display the second translated content TVC2 to the local user LU. The display may be implemented as a lens of the smart glasses, an augmented reality (AR) display, a virtual reality (VR) display, or a mixed reality (MR) display. In some embodiments, the wearable device 10 may further include a battery configured to supply power to the processor 110, the memory 130, the microphone array 160, the first speaker 140, the second speaker 150, and other components. In some embodiments, the wearable device 10 may further include one or more sensors, such as an inertial measurement unit (IMU), an ambient light sensor, a proximity sensor, or a touch sensor. In some embodiments, the wearable device 10 may further include a camera configured to capture images or videos. These additional components may cooperate with the components shown in FIG. 2 to provide various functions of the smart glasses.

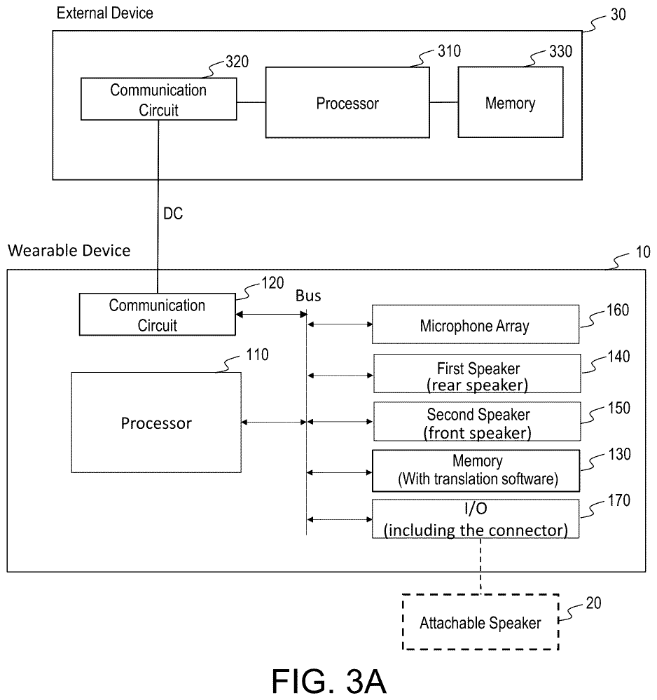

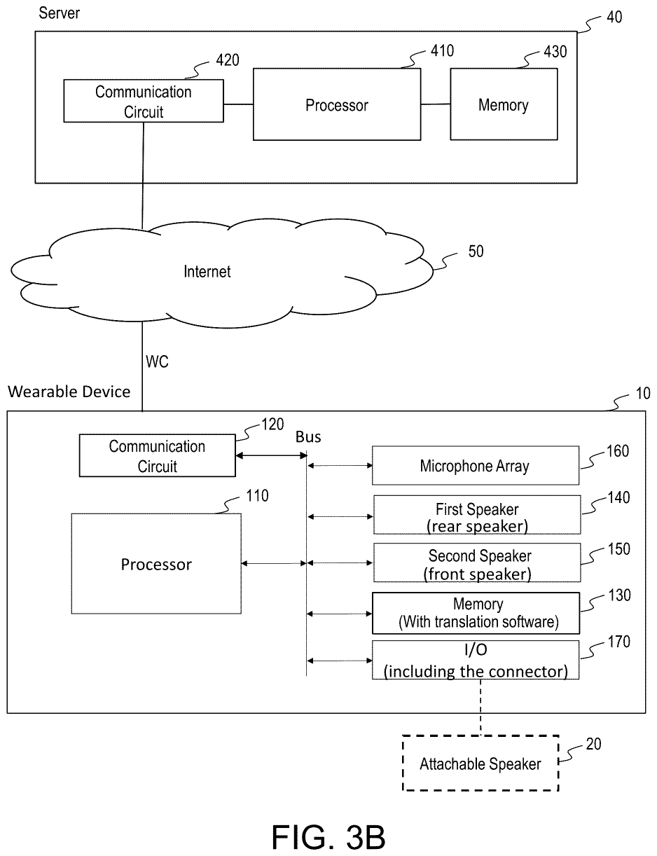

Referring to FIG. 3A, in an embodiment, a two-way translation system includes the wearable device 10 and an external device 30. The external device 30 includes a communication circuit 320, a processor 310, and a memory 330. The processor 310 is coupled to the communication circuit 320 and the memory 330. The memory 330 stores a translation program. A communication link DC is established between the wearable device 10 and the external device 30. For example, the communication link DC may be a wired connection, such as a Universal Serial Bus (USB) cable or a proprietary cable.

Compared to the embodiment of FIG. 2, the translation program in the embodiment of FIG. 3A is stored in the memory 330 of the external device 30 instead of the memory 130 of the wearable device 10. The processor 310 of the external device 30 executes the translation program to perform the translation processing instead of the processor 110 of the wearable device 10. Accordingly, the wearable device 10 in FIG. 3A may have a simplified hardware configuration with reduced processing power and memory capacity, thereby reducing the weight, size, and power consumption of the wearable device 10.

In an embodiment, the microphone array 160 of the wearable device 10 captures the first voice VC1 from the local user LU and the second voice VC2 from the target user TU. The processor 110 of the wearable device 10 transmits the first voice VC1 and the second voice VC2 to the external device 30 via the communication circuit 120 and the communication link DC. The processor 310 of the external device 30 executes the translation program stored in the memory 330 to obtain the first translated content TVC1 corresponding to the first voice VC1 and to obtain the second translated content TVC2 corresponding to the second voice VC2. The external device 30 transmits the first translated content TVC1 and the second translated content TVC2 to the wearable device 10 via the communication link DC. The wearable device 10 outputs the second translated content TVC2 to the local user LU through the first speaker 140, and outputs the first translated content TVC1 to the target user TU through the second speaker 150 (which may be disposed in the speaker module 20).

In an embodiment, the communication link DC between the wearable device 10 and the external device 30 may be established via a wired connection or a wireless connection. For example, the wired connection may include a Universal Serial Bus (USB) cable, a USB Type-C cable, a Lightning cable, a proprietary cable, or any other cable capable of transmitting audio data and power. The wireless connection may include a Bluetooth connection, a Bluetooth Low Energy (BLE) connection, a Wi-Fi connection, a Wi-Fi Direct connection, a near-field communication (NFC) connection, or any other wireless communication protocol. In some embodiments, when the communication link DC is a wireless connection, the wearable device 10 and the external device 30 may be paired in advance, and the communication link DC is automatically established when the wearable device 10 and the external device 30 are within a communication range.

In an embodiment, the external device 30 may be a smartphone, a tablet computer, a laptop computer, a personal computer, or any other computing device capable of executing the translation program. The external device 30 may have greater processing power and memory capacity compared to the wearable device 10, thereby enabling more complex translation models or algorithms to be executed for improved translation quality.

Referring to FIG. 3B, in another embodiment, the two-way translation system includes the wearable device 10 and a server 40. The server 40 includes a communication circuit 420, a processor 410, and a memory 430. The processor 410 is coupled to the communication circuit 420 and the memory 430. The memory 430 stores the translation program. A communication link WC is established between the wearable device 10 and the server 40 via the Internet 50. For example, the communication link WC may be a wireless connection, such as a Wi-Fi connection or a cellular network connection.

Compared to the embodiment of FIG. 3A, the embodiment of FIG. 3B utilizes cloud-based translation services instead of a local external device. The server 40 may be a cloud server hosted on a cloud infrastructure, and the translation program stored in the memory 430 may be a cloud-based translation service, a translation application programming interface (API), or a web-based translation service. The server 40 may leverage cloud computing resources to execute advanced translation models, such as neural machine translation (NMT) models or large language models (LLMs), which may require substantial computational resources that are not available on the wearable device 10 or a local external device.

In an embodiment, the microphone array 160 of the wearable device 10 captures the first voice VC1 from the local user LU and the second voice VC2 from the target user TU. The processor 110 of the wearable device 10 transmits the first voice VC1 and the second voice VC2 to the server 40 via the communication circuit 120, the communication link WC, and the Internet 50. The processor 410 of the server 40 executes the translation program stored in the memory 430 to obtain the first translated content TVC1 corresponding to the first voice VC1 and to obtain the second translated content TVC2 corresponding to the second voice VC2. The server 40 transmits the first translated content TVC1 and the second translated content TVC2 to the wearable device 10 via the Internet 50 and the communication link WC. The wearable device 10 outputs the second translated content TVC2 to the local user LU through the first speaker 140, and outputs the first translated content TVC1 to the target user TU through the second speaker 150 or the speaker module 20.

In some embodiments, the server 40 may provide translation services for multiple languages and may update the translation models periodically to improve translation accuracy. The wearable device 10 may access the translation services provided by the server 40 through a subscription or a pay-per-use model. In some embodiments, the wearable device 10 may switch between the local translation mode as described in FIG. 2, the external device translation mode as described in FIG. 3A, and the cloud-based translation mode as described in FIG. 3B based on network availability, translation quality requirements, or user preferences. For example, when the network connection is unstable or unavailable, the wearable device 10 automatically switches to the local translation mode or the external device translation mode to ensure continuous translation service. Conversely, when a high-speed network connection is available, the wearable device 10 prioritizes the cloud-based translation mode to provide higher translation accuracy.

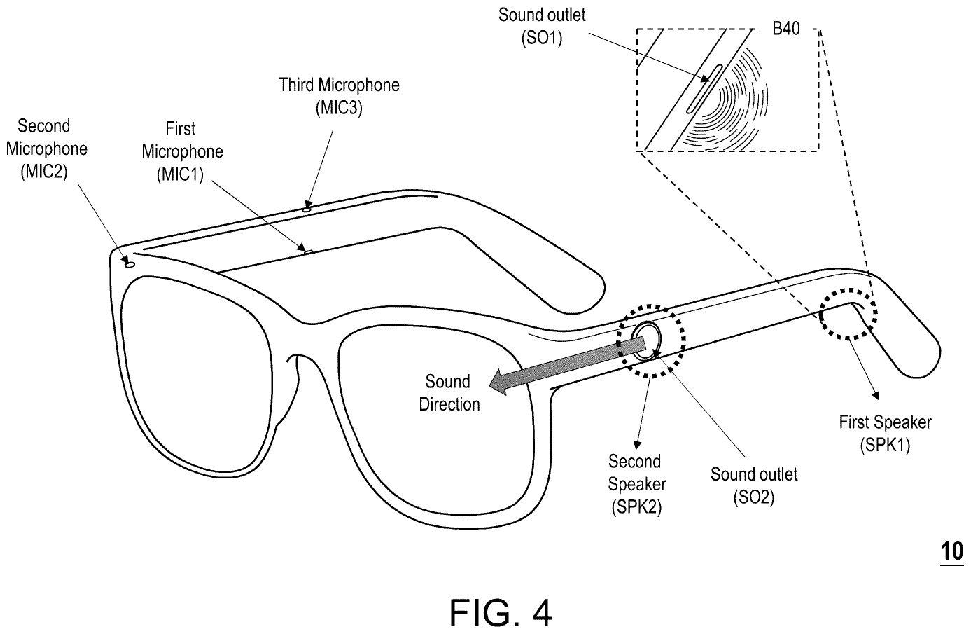

Referring to FIG. 4, in an embodiment, the wearable device 10 is implemented as smart glasses. The smart glasses include a frame, a pair of lenses, and a pair of temples extending from the frame. The one or more microphones 130, the first speaker 140, and the second speaker 150 are disposed on the smart glasses.

In an embodiment, as shown in FIG. 4, the one or more microphones 130 include a first microphone MIC1, a second microphone MIC2, and a third microphone MIC3. The first microphone MIC1 is disposed on one of the temples at a position closer to a mouth of the local user LU. The second microphone MIC2 is disposed on the frame at a position farther from the mouth of the local user LU compared to the first microphone MIC1. The third microphone MIC3 is disposed on the frame at a position between the first microphone MIC1 and the second microphone MIC2. In this configuration, the first microphone MIC1, the second microphone MIC2, and the third microphone MIC3 form a microphone array configured to capture voices from different directions. In some embodiments, the processor 110 executes a beamforming algorithm to identify source directions of the first voice VC1 and the second voice VC2 based on signals captured by the first microphone MIC1, the second microphone MIC2, and the third microphone MIC3, and to enhance signal quality of the first voice VC1 or the second voice VC2.

In an embodiment, the differential distance layout of the first microphone MIC1 and the second microphone MIC2 assists in noise suppression. Specifically, the first microphone MIC1 is disposed closer to the mouth of the local user LU and is configured to primarily capture the first voice VC1 from the local user LU with a higher signal-to-noise ratio. In some embodiments, the first microphone MIC1 has a sound inlet facing toward the mouth of the local user LU, such that the first microphone MIC1 can capture the first voice VC1 from the local user LU with improved clarity. The second microphone MIC2 is disposed farther from the mouth of the local user LU and is configured to capture environmental noise in addition to the first voice VC1 and the second voice VC2. In some embodiments, the second microphone MIC2 has a sound inlet facing a forward direction of the smart glasses, which corresponds to an expected position of the target user TU. Accordingly, the second microphone MIC2 can capture the second voice VC2 from the target user TU with improved sensitivity. The processor 110 performs noise suppression on the first voice VC1 or the second voice VC2 using the environmental noise captured by the second microphone MIC2. Furthermore, the processor 110 calculates a Time Difference of Arrival (TDOA) between the signals captured by the first microphone MIC1 and the second microphone MIC2. Based on the TDOA, the processor 110 can accurately determine the direction of the sound source and distinguish between the voice of the local user LU and the voice of the target user TU.

In an embodiment, as shown in FIG. 4, the first speaker 140 (also labeled as SPK1) is disposed on a temple of the smart glasses at a position close to an ear of the local user LU. For example, the first speaker 140 is disposed at a curved portion of the temple, such that a sound outlet SO1 of the first speaker 140 faces the ear of the local user LU. The first speaker 140 is configured to output the second translated content TVC2 to the local user LU. As shown in an enlarged view B40 in FIG. 4, the first speaker 140 adopts an open-ear acoustic structure (e.g., the sound outlet SO1) and is configured to generate a directional sound field to direct the second translated content TVC2 to the ear of the local user LU and suppress sound leakage.

In an embodiment, as shown in FIG. 4, the second speaker 150 (also labeled as SPK2) is disposed on the temple of the smart glasses. The second speaker 150 has a sound outlet SO2 facing a direction away from the local user LU, such as a forward direction as indicated by the arrow labeled “Sound Direction” in FIG. 4. The second speaker 150 is configured to output the first translated content TVC1 to the target user TU. Since the sound outlet SO2 of the second speaker 150 faces the forward direction, the first translated content TVC1 can be outputted toward the target user TU who is positioned in front of the local user LU.

In an embodiment, the first speaker 140 and the second speaker 150 are disposed on the same temple of the smart glasses, as shown in FIG. 4. In other embodiments, the first speaker 140 and the second speaker 150 may be disposed on different temples of the smart glasses. In various embodiments, the smart glasses may include more than one first speaker 140 and/or more than one second speaker 150 disposed on one or both temples to provide louder sound or stereo sound.

In an embodiment, the processor 110 performs echo cancellation to remove acoustic feedback from the captured voice signals. Specifically, the first speaker 140 outputs the second translated content TVC2, and the second speaker 150 outputs the first translated content TVC1. Since the audio signals output by the first speaker 140 and the second speaker 150 are known to the processor 110, the processor 110 can utilize these known audio signals to filter out the corresponding acoustic echoes from the signals captured by the one or more microphones 130. For example, the processor 110 performs echo cancellation on the signals captured by the first microphone MIC1 using the audio signals output by the first speaker 140, thereby removing the acoustic feedback of the second translated content TVC2 from the captured signals of the first microphone MIC1. Similarly, the processor 110 performs echo cancellation on the signals captured by the second microphone MIC2 using the audio signals output by the second speaker 150, thereby removing the acoustic feedback of the first translated content TVC1 from the captured signals of the second microphone MIC2. Accordingly, the processor 110 can obtain cleaner voice signals of the first voice VC1 and the second voice VC2 for translation processing.

In some embodiments, the processor 110 also performs echo cancellation on the signals captured by the third microphone MIC3. Since the third microphone MIC3 is disposed at a position between the first microphone MIC1 and the second microphone MIC2, the third microphone MIC3 may capture acoustic echoes from both the first speaker 140 and the second speaker 150. Accordingly, the processor 110 performs echo cancellation on the signals captured by the third microphone MIC3 using both the audio signals output by the first speaker 140 and the audio signals output by the second speaker 150, thereby removing the acoustic feedback of the second translated content TVC2 and the acoustic feedback of the first translated content TVC1 from the captured signals of the third microphone MIC3.

In some embodiments, the third microphone MIC3 is utilized as a reference microphone for capturing environmental noise. Since the third microphone MIC3 is disposed at a position on the frame between the first microphone MIC1 and the second microphone MIC2, the third microphone MIC3 may be less sensitive to the first voice VC1 from the local user LU compared to the first microphone MIC1, and may also be less sensitive to the second voice VC2 from the target user TU compared to the second microphone MIC2. Accordingly, the signals captured by the third microphone MIC3 may contain a higher proportion of environmental noise relative to the target voices. The processor 110 performs noise suppression on the first voice VC1 captured by the first microphone MIC1 using the environmental noise captured by the third microphone MIC3, thereby obtaining a cleaner signal of the first voice VC1. Similarly, the processor 110 performs noise suppression on the second voice VC2 captured by the second microphone MIC2 using the environmental noise captured by the third microphone MIC3, thereby obtaining a cleaner signal of the second voice VC2.

In some embodiments, the processor 110 further refines the environmental noise captured by the third microphone MIC3 by removing voice components from the signals captured by the third microphone MIC3. Specifically, since the first microphone MIC1 captures the first voice VC1 with higher clarity and the second microphone MIC2 captures the second voice VC2 with higher clarity, the processor 110 may utilize the first voice VC1 captured by the first microphone MIC1 to subtract a corresponding voice component from the signals captured by the third microphone MIC3. Similarly, the processor 110 may utilize the second voice VC2 captured by the second microphone MIC2 to subtract a corresponding voice component from the signals captured by the third microphone MIC3. Accordingly, the signals captured by the third microphone MIC3 are refined to contain a higher proportion of environmental noise and a lower proportion of voice components. The refined environmental noise captured by the third microphone MIC3 can then be used more effectively for noise suppression on the first voice VC1 captured by the first microphone MIC1 and the second voice VC2 captured by the second microphone MIC2. In this manner, the first microphone MIC1, the second microphone MIC2, and the third microphone MIC3 cooperatively function to separate and enhance the first voice VC1, the second voice VC2, and the environmental noise, thereby improving overall audio quality for translation processing.

In various embodiments, each of the first microphone MIC1, the second microphone MIC2, and the third microphone MIC3 is not limited to a single microphone element, and may be configured as a microphone array comprising a plurality of microphone elements. For example, the first microphone MIC1 may be implemented as a first microphone array comprising a plurality of microphone elements disposed at a position closer to the mouth of the local user LU. Similarly, the second microphone MIC2 may be implemented as a second microphone array comprising a plurality of microphone elements disposed at a position farther from the mouth of the local user LU and facing a forward direction toward the target user TU. The third microphone MIC3 may be implemented as a third microphone array comprising a plurality of microphone elements configured to capture environmental noise. Accordingly, the wearable device 10 may include one, two, or three microphone arrays, depending on the design requirements and the desired level of audio processing performance.

In an embodiment, the wearable device 10 is a dedicated translation device configured to perform the two-way language translation function. Unlike general-purpose smart glasses that integrate multiple functions such as augmented reality display, navigation, fitness tracking, and multimedia playback, the wearable device 10 in this embodiment focuses on providing the two-way language translation function. The wearable device 10 may have a simplified hardware configuration that includes the one or more microphones 130, the first speaker 140, the second speaker 150 or the speaker module 20, the processor 110, and the memory 130, without including additional components such as a high-resolution display, a high-performance graphics processor, or multiple sensors for augmented reality applications. Accordingly, the wearable device 10 can be manufactured at a lower cost, with a lighter weight, and with a longer battery life compared to general-purpose smart glasses, making the wearable device 10 more accessible for users who primarily need translation assistance during cross-language communication.

In an embodiment, the wearable device 10 further includes a camera disposed on the frame of the smart glasses and facing a forward direction. The camera is configured to capture images or video of the target user TU. The processor 110 is configured to analyze the images or video captured by the camera to recognize visual communication cues from the target user TU. For example, the processor 110 may execute a lip-reading algorithm to recognize lip movements of the target user TU and convert the recognized lip movements into text or speech corresponding to the second voice VC2. In some embodiments, the processor 110 may execute a sign language recognition algorithm to recognize hand gestures and body movements of the target user TU and convert the recognized sign language into text or speech corresponding to the second voice VC2. Accordingly, the wearable device 10 can translate communications from the target user TU even when the target user TU is unable to speak or when the ambient noise level is too high for the one or more microphones 130 to capture the second voice VC2 clearly. In some embodiments, the processor 110 combines the visual communication cues recognized from the images or video captured by the camera with the second voice VC2 captured by the one or more microphones 130 to improve translation accuracy.

It should be noted that the second speaker 150 (SPK2) shown in FIG. 4 is an exemplary implementation and is not intended to limit the shape, size, or position of the second speaker 150 in the present disclosure. In other embodiments, the second speaker 150 may have different shapes, such as a cylindrical shape, a rectangular shape, an oval shape, or any other shape suitable for integration into the wearable device 10. In other embodiments, the second speaker 150 may be disposed at different positions on the smart glasses, such as on a bridge, a frame, a hinge, or a different portion of the temple. In various embodiments, the sound outlet of the second speaker 150 may face different directions, such as a forward direction, a downward direction, a sideward direction, or any other direction that allows the first translated content TVC1 to be transmitted to the target user TU. As long as the second speaker 150 is configured to output the first translated content TVC1 to the target user TU, the second speaker 150 falls within the scope of the present disclosure regardless of its shape, size, or position on the wearable device 10.

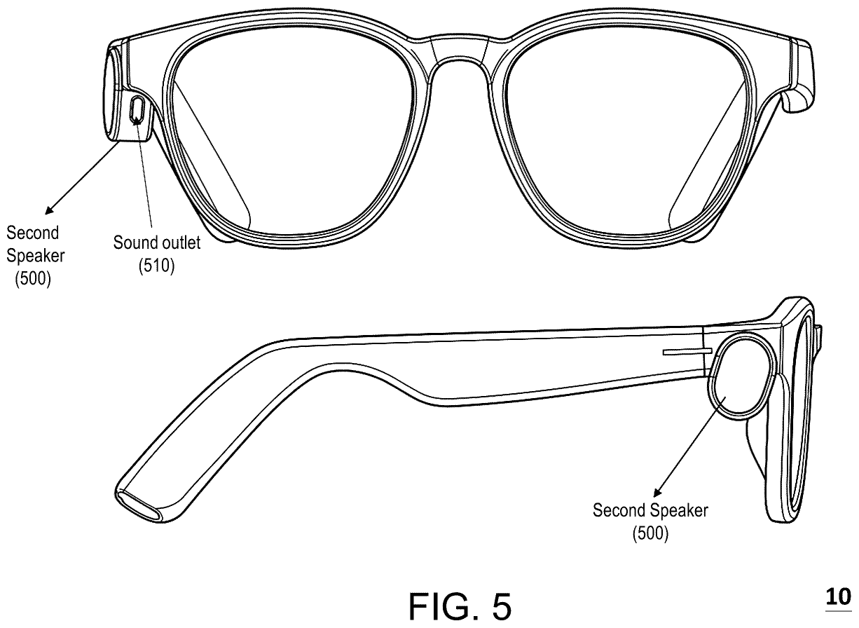

Referring to FIG. 5, in an embodiment, the wearable device 10 includes an integrated second speaker 500. The integrated second speaker 500 is built into and embedded within the wearable device 10 at a position near a hinge area where a temple connects to a frame of the smart glasses. As shown in FIG. 5, the integrated second speaker 500 has a sound outlet 510 facing a forward direction, such that the first translated content TVC1 can be projected toward the target user TU who is positioned in front of the local user LU. In this embodiment, the integrated second speaker 500 is a permanent component of the wearable device 10 and cannot be detached by the local user LU. The integrated second speaker 500 shown in FIG. 5 is an exemplary implementation of the second speaker 150 described in the embodiment of FIG. 2.

In an embodiment, the wearable device 10 may include two integrated second speakers 500, each disposed at a corresponding position on left and right sides of the frame. The two integrated second speakers 500 may operate together to provide louder sound or stereo sound to the target user TU. In some embodiments, the sound outlet 510 of the integrated second speaker 500 may face a sideward direction instead of a forward direction, and the first translated content TVC1 can still be transmitted to the target user TU within a distance of one to two meters from the local user LU.

In an embodiment, the integrated second speaker 500 may include multiple sound outlets 510 facing different directions. For example, the integrated second speaker 500 may include a first sound outlet 510a facing a forward direction and a second sound outlet 510b facing a sideward direction. The first sound outlet 510a and the second sound outlet 510b may be acoustically coupled to a same speaker driver within the integrated second speaker 500, or may be respectively coupled to different speaker drivers. In some embodiments, the wearable device 10 includes a plurality of integrated second speakers 500, wherein at least one integrated second speaker 500 has a sound outlet 510 facing a forward direction and at least another integrated second speaker 500 has a sound outlet 510 facing a sideward direction.

In an embodiment, the processor 110 is configured to determine a direction of the target user TU relative to the local user LU, and selectively activate one or more of the sound outlets 510 based on the determined direction. Specifically, the processor 110 may utilize the microphone array 160 and the beamforming algorithm to identify the direction from which the second voice VC2 of the target user TU originates. Based on the identified direction, the processor 110 selects the sound outlet 510 that is most suitable for transmitting the first translated content TVC1 to the target user TU. For example, when the target user TU is located in front of the local user LU, the processor 110 activates the first sound outlet 510a facing the forward direction. When the target user TU is located to a side of the local user LU, the processor 110 activates the second sound outlet 510b facing the sideward direction. In some embodiments, when the target user TU is located at an intermediate angle between the forward direction and the sideward direction, the processor 110 activates both the first sound outlet 510a and the second sound outlet 510b simultaneously to provide broader sound coverage. In some embodiments, the processor 110 dynamically adjusts the activation of the sound outlets 510 in real-time as the target user TU moves relative to the local user LU during the conversation.

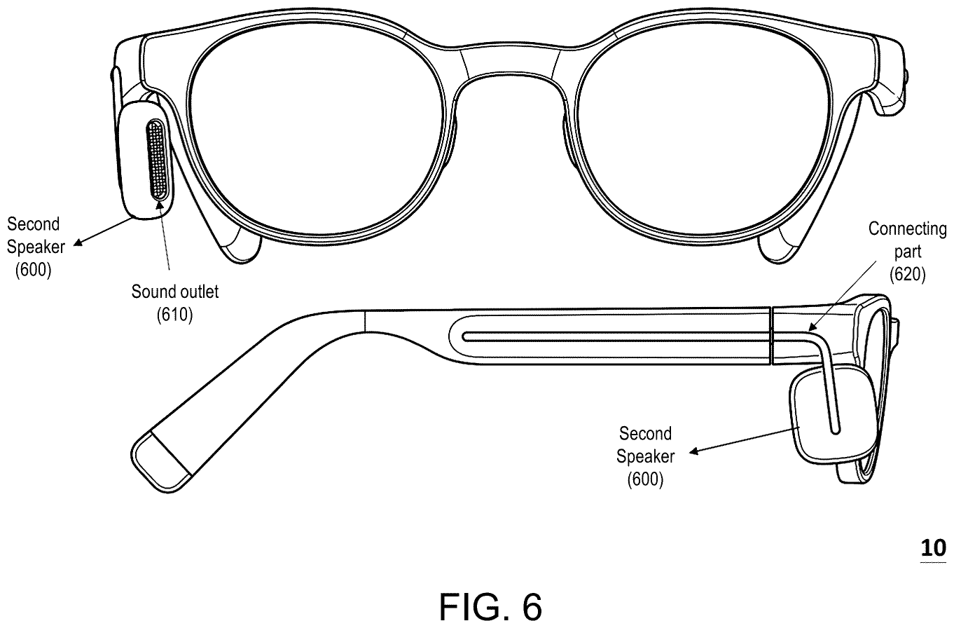

Referring to FIG. 6, in an embodiment, the wearable device 10 includes a second speaker 600 connected to the wearable device 10 via a connecting part 620. The second speaker 600 is a separate component from the frame and the temple of the smart glasses, and is integrated to the wearable device 10 through the connecting part 620. As shown in FIG. 6, the second speaker 600 has a sound outlet 610 facing a forward direction, and the sound outlet 610 includes a plurality of apertures configured to allow sound waves to pass through. The connecting part 620 may be a rigid structure, a flexible structure, or a combination thereof, and may be permanently attached to the wearable device 10 or detachably coupled to the wearable device 10.

In an embodiment, the connecting part 620 electrically couples the second speaker 600 to the wearable device 10 for transmitting audio signals and power. For example, the connecting part 620 may include electrical wires embedded therein for transmitting the first translated content TVC1 from the processor 110 to the second speaker 600. In some embodiments, the connecting part 620 may include a hinge mechanism that allows the second speaker 600 to be rotated or adjusted in angle relative to the frame of the smart glasses, such that the local user LU can adjust the direction of the sound outlet 610 to optimize sound projection toward the target user TU.

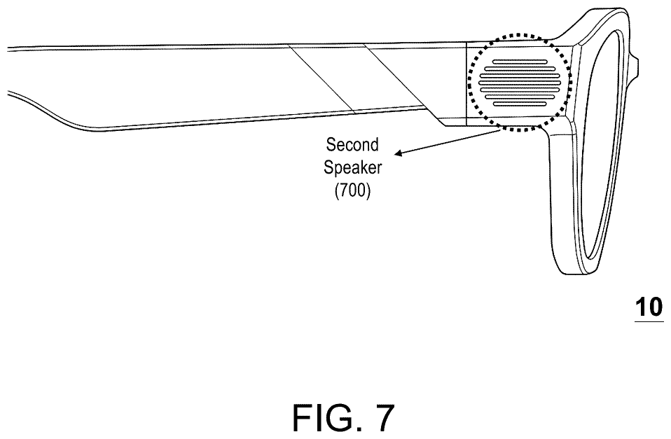

Referring to FIG. 7, in an embodiment, the wearable device 10 includes a second speaker 700 disposed at a hinge of the smart glasses. The hinge is a joint structure connecting the temple to the frame of the smart glasses. As shown in FIG. 7, the second speaker 700 is integrated into the hinge area and has a sound outlet facing a sideward direction of the smart glasses. The sound outlet of the second speaker 700 includes a plurality of slits or apertures configured to allow sound waves to pass through while maintaining structural integrity of the hinge.

In an embodiment, the hinge location of the second speaker 700 provides an advantageous position for projecting sound toward the target user TU, as the hinge is located at a forward portion of the smart glasses relative to the temple. Compared to the second speaker 150 disposed on the temple as shown in FIG. 4, the second speaker 700 disposed at the hinge as shown in FIG. 7 may project sound more directly toward the target user TU without obstruction from the temple structure. In some embodiments, the wearable device 10 may include two second speakers 700, each disposed at a corresponding hinge on left and right sides of the smart glasses.

It should be noted that the second speakers 500, 600, and 700 shown in FIG. 5, FIG. 6, and FIG. 7 are exemplary implementations of the second speaker 150 described in FIG. 2, and are not intended to limit the configurations of the second speaker 150 in the present disclosure. In various embodiments, the second speaker 150 may be disposed at different positions on the wearable device 10, such as on a bridge, a frame front, a temple tip, or any other position that allows the first translated content TVC1 to be transmitted to the target user TU.

In some embodiments, a single speaker module may be configured to output audio to both the local user LU and the target user TU through different sound outlets. Specifically, the speaker module may include a first sound outlet facing the local user LU and a second sound outlet facing a direction away from the local user LU. The speaker module outputs the second translated content TVC2 to the local user LU through the first sound outlet, and outputs the first translated content TVC1 to the target user TU through the second sound outlet. For example, referring to FIG. 6, the second speaker 600 may be modified to include an additional sound outlet on a rear side of the second speaker 600 facing the local user LU, in addition to the sound outlet 610 on a front side facing the target user TU. In this configuration, the second speaker 600 functions as both the first speaker 140 and the second speaker 150, and the wearable device 10 may omit a separate first speaker disposed on the temple. Accordingly, the wearable device 10 can achieve the two-way translation function using a single speaker module with dual sound outlets, thereby simplifying the hardware configuration and reducing the manufacturing cost of the wearable device 10.

Similarly, referring to FIG. 7, the second speaker 700 disposed at the hinge of the smart glasses may also include dual sound outlets. Since the hinge is located at a junction between the temple and the frame, the second speaker 700 may have a first sound outlet facing an inward direction toward the local user LU and a second sound outlet facing an outward direction toward the target user TU. The inward-facing sound outlet outputs the second translated content TVC2 to the local user LU, and the outward-facing sound outlet outputs the first translated content TVC1 to the target user TU. In this configuration, the hinge location of the second speaker 700 provides a natural separation between the inward and outward sound outlets, allowing the single speaker module to effectively serve both the local user LU and the target user TU.

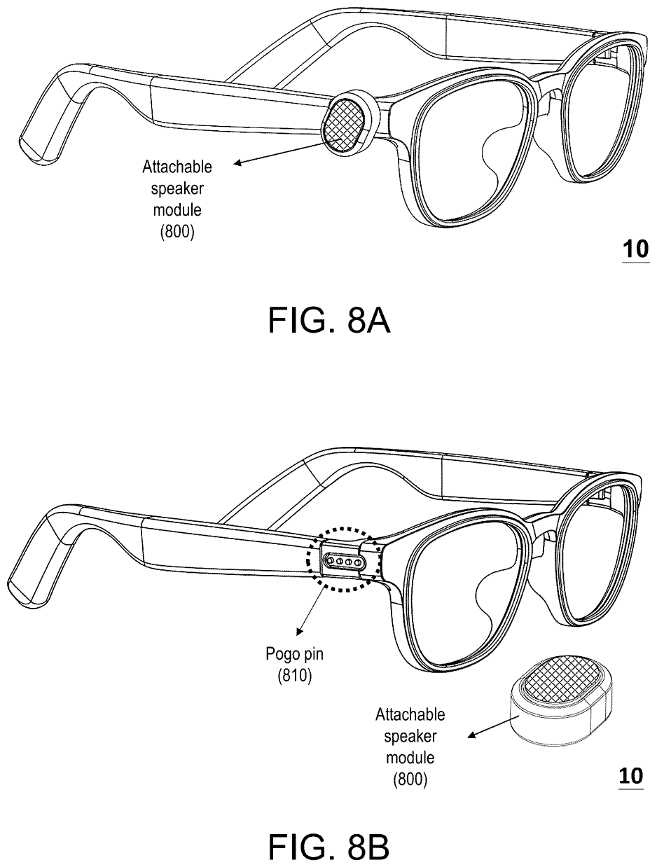

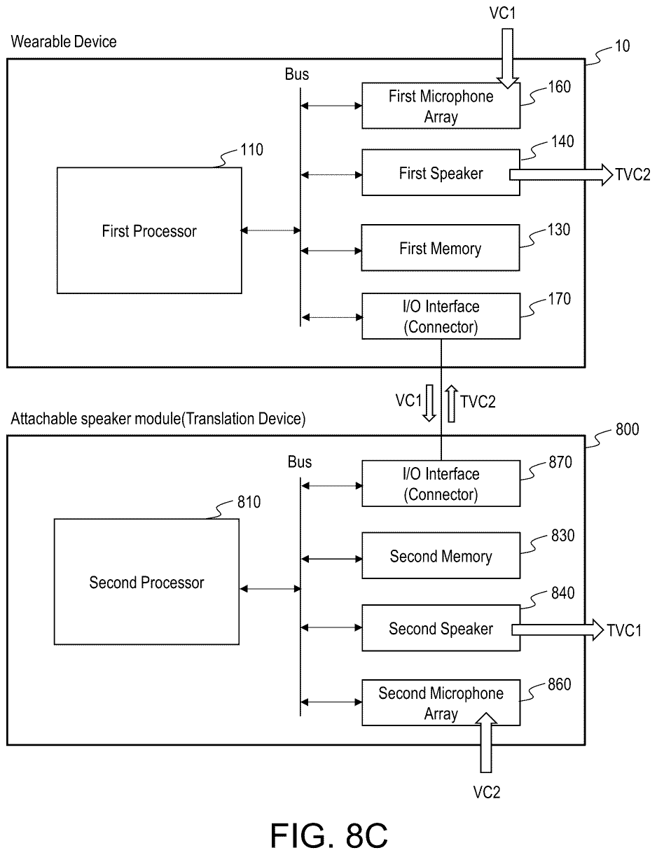

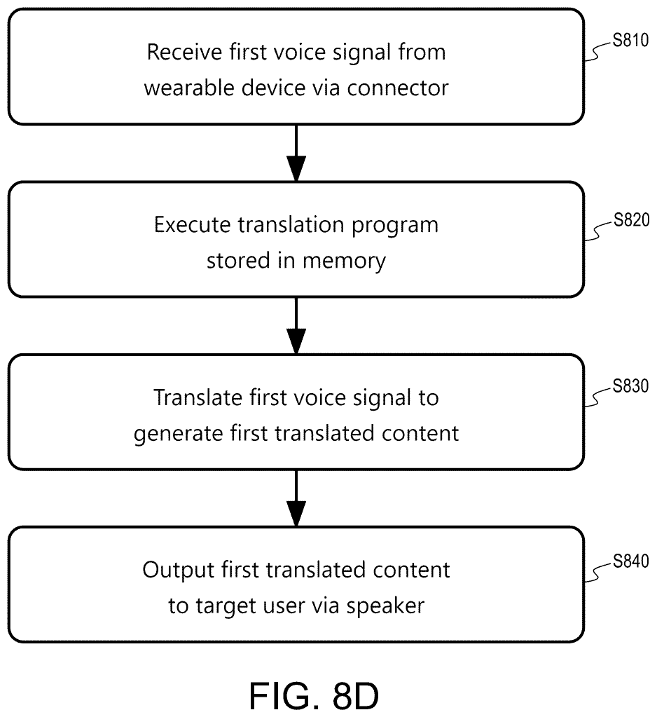

Referring to FIG. 8A and FIG. 8B, in an embodiment, the wearable device 10 includes an attachable speaker module 800 that is detachably coupled to the wearable device 10. FIG. 8A illustrates the attachable speaker module 800 attached to the wearable device 10, and FIG. 8B illustrates the attachable speaker module 800 detached from the wearable device 10. The attachable speaker module 800 includes the second speaker 150 and is configured to output the first translated content TVC1 to the target user TU when the attachable speaker module 800 is attached to the wearable device 10. The attachable speaker module 800 shown in FIG. 8A and FIG. 8B is an exemplary implementation of the speaker module 20 described in the embodiment of FIG. 2.

As shown in FIG. 8B, the wearable device 10 includes a plurality of pogo pins 810 disposed on a surface of the wearable device 10. The plurality of pogo pins 810 are configured to electrically couple the attachable speaker module 800 to the wearable device 10 when the attachable speaker module 800 is attached to the wearable device 10. Specifically, the attachable speaker module 800 includes a plurality of contact pads (not shown) corresponding to the plurality of pogo pins 810. When the attachable speaker module 800 is attached to the wearable device 10, the plurality of pogo pins 810 contact the plurality of contact pads of the attachable speaker module 800, thereby establishing electrical connections between the wearable device 10 and the attachable speaker module 800. The plurality of pogo pins 810 are configured to transmit audio signals and power from the wearable device 10 to the attachable speaker module 800.

In an embodiment, the attachable speaker module 800 has a cylindrical shape, as shown in FIG. 8B. In other embodiments, the attachable speaker module 800 may have different shapes, such as a rectangular shape, an oval shape, a polygonal shape, or any other shape suitable for attachment to the wearable device 10. In some embodiments, the attachable speaker module 800 may include a battery for storing power received from the wearable device 10 or for independently powering the second speaker 150 in the attachable speaker module 800.

Referring to FIG. 8C, in an embodiment, the attachable speaker module 800 is configured as a self-contained translation device capable of upgrading the functionality of the wearable device 10. As shown in the block diagram of FIG. 8C, the wearable device 10 includes a first processor 110, a first memory 130, a first microphone array 160, a first speaker 140, and an I/O interface 170 (e.g., a connector). The attachable speaker module 800 includes a housing, a second processor 810, a second memory 830, a second speaker 840, a second microphone array 860, and an I/O interface 870 (e.g., a connector). The second processor 810, the second memory 830, and the second speaker 840 are disposed within the housing. The I/O interface 870 is disposed on the housing to facilitate connection with the wearable device 10. The second processor 810 is coupled to the second memory 830, the second speaker 840, the second microphone array 860, and the I/O interface 870 via a bus. When the attachable speaker module 800 is attached to the wearable device 10, the I/O interface 870 of the attachable speaker module 800 is electrically coupled to the I/O interface 170 of the wearable device 10, establishing a data and power transmission path between the two devices.

In an embodiment, the attachable speaker module 800 functions as a translation device. The second memory 830 stores a translation program, and the second processor 810 executes the translation program to perform translation operations. In this configuration, the wearable device 10 may act primarily as an input/output interface for the local user LU, while the computationally intensive translation tasks are offloaded to the attachable speaker module 800. Specifically, the first microphone array 160 captures the first voice VC1 from the local user LU, and the first processor 110 transmits audio data of the first voice VC1 to the attachable speaker module 800 via the I/O interface 170. The second processor 810 receives the audio data via the I/O interface 870, translates the first voice VC1 into the first translated content TVC1, and outputs the first translated content TVC1 through the second speaker 840 to the target user TU.

In an embodiment, the attachable speaker module 800 utilizes the second microphone array 860 to enhance voice captured from the target user TU. The second microphone array 860 may be positioned on the attachable speaker module 800 to face a forward direction or a direction away from the local user LU, thereby providing better signal quality for capturing the second voice VC2 compared to the first microphone array 160 disposed on the wearable device 10. In this configuration, the attachable speaker module 800 captures the second voice VC2 using the second microphone array 860. The second processor 810 processes the second voice VC2 to generate the second translated content TVC2. The second processor 810 then transmits the second translated content TVC2 to the wearable device 10 via the I/O interface 870. The first processor 110 receives the second translated content TVC2 via the I/O interface 170 and outputs it to the local user LU through the first speaker 140.

In an embodiment, a data flow between the wearable device 10 and the attachable speaker module 800 is coordinated as follows. The first microphone array 160 captures the first voice VC1 and generates a first audio signal. The first processor 110 transmits the first audio signal to the second processor 810 via the connection between the I/O interface 170 and the I/O interface 870. The second processor 810 executes the translation program to translate the first voice VC1 and generate the first translated content TVC1. The second speaker 840 outputs the first translated content TVC1. Simultaneously or sequentially, the second microphone array 860 captures the second voice VC2 and generates a second audio signal. The second processor 810 translates the second voice VC2 and generates the second translated content TVC2. The second processor 810 transmits the second translated content TVC2 to the first processor 110 via the connection between the I/O interface 870 and the I/O interface 170. The first speaker 140 outputs the second translated content TVC2. This distributed architecture allows for efficient processing and optimal audio input/output placement for both users.

In an embodiment, the attachable speaker module 800 is designed as an upgrade accessory for extending the functionality of existing smart glasses. In this scenario, the wearable device 10 may be a conventional smart glasses product that includes basic components such as the first processor 110, the first memory 130, the first microphone array 160, and the first speaker 140, but lacks a built-in translation program or sufficient processing power for real-time translation. When the attachable speaker module 800 is attached to the wearable device 10, the two-way translation functionality is enabled by the hardware and software resources provided by the attachable speaker module 800 (i.e., the second processor 810, the second memory 830, and the second speaker 840). This modular approach allows users to selectively add advanced translation capabilities to their existing devices without replacing the entire wearable device 10, thereby reducing cost and extending the device's lifespan.

In an embodiment, the attachable speaker module 800 further includes a communication circuit (not shown in FIG. 8C) coupled to the second processor 810. The communication circuit is configured to establish a communication link with an external server (or an external device). The second processor 810 may offload computationally intensive translation tasks to the external server via the communication link. In this configuration, the attachable speaker module 800 transmits voice signals (captured by the first microphone array 160 or the second microphone array 860) to the external server, receives translated content from the external server, and outputs the translated content through the second speaker 840 or transmits it to the first speaker 140. The communication circuit may support wireless communication protocols such as Wi-Fi, Bluetooth, or cellular network protocols. In some embodiments, the attachable speaker module 800 includes a subscriber identity module (SIM) card slot for connecting to a cellular network independently of the wearable device 10.

It should be noted that the terms “module,” “unit,” or “device” as used herein, such as the “speaker module,” “attachable speaker module,” or “translation device,” refer to tangible hardware components implemented by physical circuitry. These components may include, but are not limited to, application-specific integrated circuits (ASICs), field-programmable gate arrays (FPGAs), microprocessors, microcontrollers, memory devices, and passive electronic components mounted on a printed circuit board (PCB) and housed within a physical casing. These terms are not intended to be construed as purely software or abstract concepts without physical structure.

Referring to FIG. 8D, in an embodiment, FIG. 8D is a flowchart illustrating an operation process performed by the attachable speaker module 800 (i.e., the translation device). The operation process includes steps S810, S820, S830, and S840.

At step S810, the attachable speaker module 800 receives a first voice signal from the wearable device 10 via the connector (e.g., the I/O interface 870). The first voice signal corresponds to the first voice VC1 captured by the first microphone array 160 of the wearable device 10. The connector establishes an electrical connection between the wearable device 10 and the attachable speaker module 800 for data transmission.

At step S820, the second processor 810 disposed within the housing of the attachable speaker module 800 executes the translation program stored in the second memory 830. In this embodiment, the translation program is executed locally by the second processor 810 of the attachable speaker module 800.

At step S830, the second processor 810 translates the first voice signal from the first language to the second language to generate the first translated content TVC1. At step S840, the second speaker 840 disposed within the housing outputs the first translated content TVC1 to the target user TU.

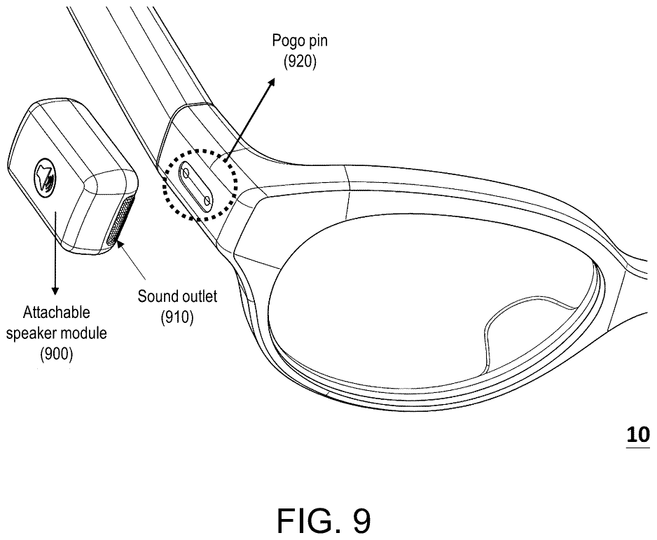

Referring to FIG. 9, in an embodiment, the wearable device 10 includes an attachable speaker module 900 and a plurality of pogo pins 920. The attachable speaker module 900 has a sound outlet 910 configured to output the first translated content TVC1 to the target user TU. As shown in FIG. 9, the sound outlet 910 includes a plurality of apertures arranged in a mesh pattern, allowing sound waves to pass through while protecting internal components of the attachable speaker module 900.

As shown in FIG. 9, the plurality of pogo pins 920 are disposed on a surface of the wearable device 10 at a position near a hinge of the smart glasses. The plurality of pogo pins 920 are exposed when the attachable speaker module 900 is detached from the wearable device 10. When the attachable speaker module 900 is attached to the wearable device 10, the attachable speaker module 900 covers the plurality of pogo pins 920, and the plurality of pogo pins 920 contact corresponding contact pads of the attachable speaker module 900 to establish electrical connections for transmitting audio signals and power.

In an embodiment, the attachable speaker module 900 has a rectangular shape with rounded corners, as shown in FIG. 9. The sound outlet 910 is disposed on a front surface of the attachable speaker module 900 facing a forward direction when the attachable speaker module 900 is attached to the wearable device 10, such that the first translated content TVC1 can be projected toward the target user TU. Compared to the attachable speaker module 800 shown in FIG. 8A and FIG. 8B, the attachable speaker module 900 shown in FIG. 9 has a different shape and a different sound outlet design, demonstrating that the attachable speaker module may have various configurations without departing from the scope of the present disclosure.

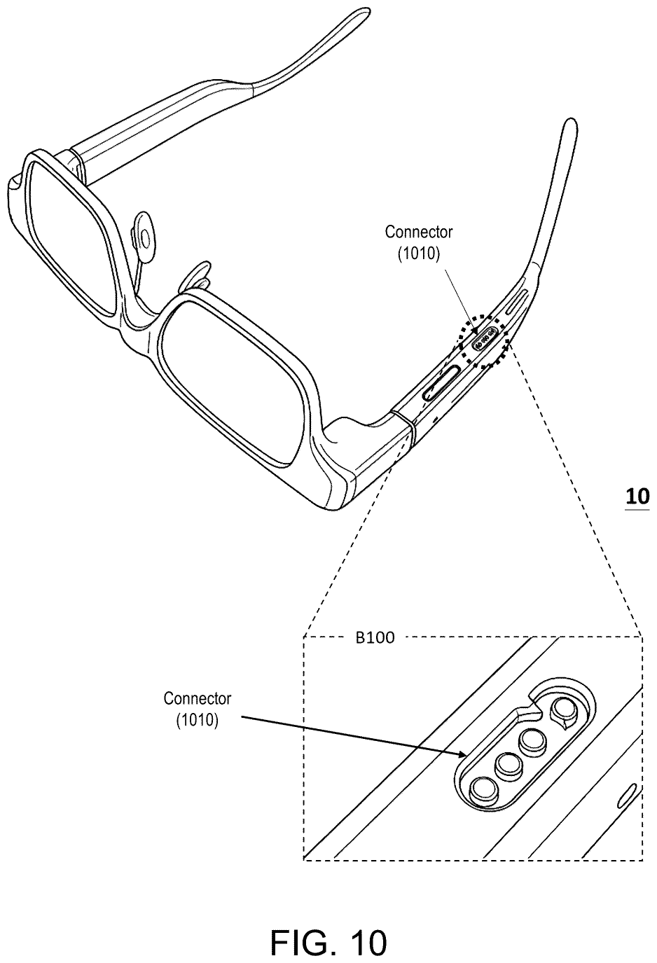

Referring to FIG. 10, in an embodiment, the wearable device 10 includes a connector 1010 disposed on a surface of the wearable device 10. The connector 1010 is configured to electrically couple the attachable speaker module (e.g., the speaker module 20, the attachable speaker module 800, or the attachable speaker module 900) to the wearable device 10. As shown in an enlarged view B100 of FIG. 10, the connector 1010 includes a plurality of pogo pins arranged in a specific pattern.

In an embodiment, as shown in the enlarged view B100 of FIG. 10, the connector 1010 includes four pogo pins. In some embodiments, at least one pogo pin of the connector 1010 is configured to transmit power, and at least another one pogo pin of the connector 1010 is configured to transmit audio signals. In other embodiments, a same pogo pin of the connector 1010 may be configured to transmit both power and data. In various embodiments, the connector 1010 may include a different number of pogo pins, such as two, three, five, or more pogo pins, depending on the transmission requirements.

In an embodiment, the connector 1010 is disposed on a bottom surface of the temple of the smart glasses, as shown in FIG. 10. In other embodiments, the connector 1010 may be disposed on a top surface of the temple, a side surface of the temple, or any other surface of the wearable device 10 that allows the attachable speaker module to be attached. In some embodiments, the connector 1010 may be the same connector originally used for power supply and data transmission of the wearable device 10. In other words, the same connector 1010 may be used to connect a charging cable for charging the wearable device 10 and to connect the attachable speaker module for the two-way translation function.

In an embodiment, the wearable device 10 further includes a magnetic component disposed around the connector 1010 or embedded in the attachable speaker module. The magnetic component is configured to assist in alignment and attachment of the attachable speaker module to the connector 1010. Specifically, when the local user LU brings the attachable speaker module close to the connector 1010, the magnetic component generates a magnetic attraction force that guides the attachable speaker module to the correct position and orientation, ensuring that the contact pads of the attachable speaker module are precisely aligned with the plurality of pogo pins of the connector 1010. Accordingly, the magnetic component facilitates quick and accurate attachment of the attachable speaker module to the wearable device 10, and ensures stable electrical and data connections between the attachable speaker module and the wearable device 10.

It should be noted that the connector 1010 is not limited to a pogo pin connector, and may alternatively be implemented using other types of electrical connectors, such as a Universal Serial Bus (USB) connector, a magnetic connector, a spring tab connector, or any other connection structure configured for power and/or data transmission.

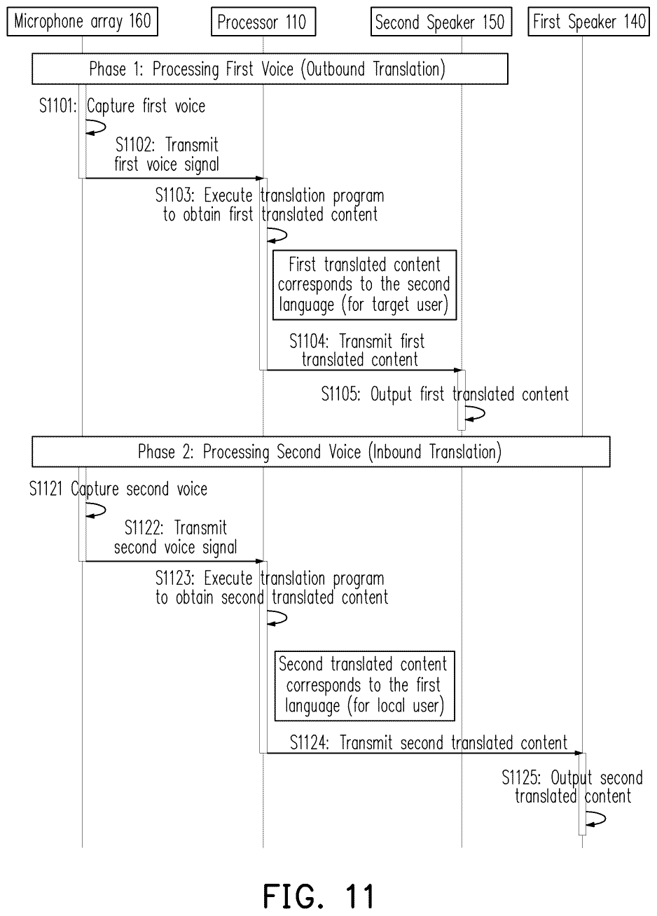

Referring to FIG. 11, in an embodiment, FIG. 11 is a sequence diagram illustrating a two-way language translation method performed by the wearable device 10. The two-way language translation method includes a first phase for processing a first voice VC1 (outbound translation) and a second phase for processing a second voice VC2 (inbound translation). The first phase and the second phase may be performed sequentially or in parallel, depending on whether the local user LU and the target user TU are speaking simultaneously.

In the first phase (Phase 1: Processing First Voice-Outbound Translation), at step S1101, the microphone array 160 captures the first voice VC1 from the local user LU (e.g., when the local user is speaking, the voice of the local user is captured by the microphone array 160). The first voice VC1 corresponds to a first language of the local user LU. At step S1102, the microphone array 160 transmits a first voice signal indicative of the first voice VC1 to the processor 110. At step S1103, the processor 110 executes the translation program stored in the memory 130 to obtain the first translated content TVC1 corresponding to the first voice VC1. The first translated content TVC1 corresponds to a second language of the second voice VC2, such that the target user TU can understand the first translated content TVC1. At step S1104, the processor 110 transmits the first translated content TVC1 to the second speaker 150. At step S1105, the second speaker 150 outputs the first translated content TVC1 to the target user TU.

In an embodiment, the processor 110 translates the first voice VC1 into the first translated content TVC1 in the second language. The second language may be determined automatically or manually. In one example, the processor 110 executes the language identification algorithm to identify the language type of the second voice VC2 captured from the target user TU, and sets the identified language type as the second language for translating the first voice VC1. In another example, the local user LU specifies the second language. Specifically, the local user LU may issue a voice command (e.g., “translate to Japanese”) to the wearable device 10. Alternatively, the wearable device 10 may execute a two-way translation application, and the local user LU may configure the second language directly through a user interface displayed on the display of the wearable device 10 (e.g., an augmented reality user interface). This allows the local user LU to intuitively adjust settings within the application running on the wearable device 10 without relying on the external device 30 (e.g., a smartphone). In yet another embodiment, the local user LU may configure the second language through a companion application running on the external device 30.

In the second phase (Phase 2: Processing Second Voice-Inbound Translation), at step S1121, the microphone array 160 captures the second voice VC2 from the target user TU. The second voice VC2 corresponds to the second language of the target user TU. At step S1122, the microphone array 160 transmits a second voice signal indicative of the second voice VC2 to the processor 110. At step S1123, the processor 110 executes the translation program stored in the memory 130 to obtain the second translated content TVC2 corresponding to the second voice VC2. The second translated content TVC2 corresponds to the first language of the first voice VC1, such that the local user LU can understand the second translated content TVC2. At step S1124, the processor 110 transmits the second translated content TVC2 to the first speaker 140. At step S1125, the first speaker 140 outputs the second translated content TVC2 to the local user LU.

In an embodiment, the processor 110 translates the second voice VC2 into the second translated content TVC2 in the first language. The first language may be determined based on a preset setting or the language used by the local user LU. In one example, the processor 110 retrieves a preferred language setting of the local user LU stored in the memory 130 and sets the preferred language as the first language. The preferred language setting may be configured by the local user LU via the user interface of the wearable device 10 or the external device 30. In another example, the processor 110 executes the language identification algorithm to identify the language type of the first voice VC1 spoken by the local user LU, and sets the identified language type as the first language for translating the second voice VC2. Accordingly, the processor 110 can dynamically adapt the translation of the second voice VC2 to match the language currently spoken by the local user LU.

In an embodiment, the processor 110 is configured to generate the first translated content TVC1 or the second translated content TVC2 in real-time while the first voice VC1 or the second voice VC2 is still in progress. Accordingly, the wearable device 10 does not need to wait for the local user LU or the target user TU to complete a sentence before starting translation and outputting the translated content.

In an embodiment, when the local user LU and the target user TU are speaking simultaneously, the processor 110 is configured to synchronously convert the first voice VC1 and the second voice VC2 into the first translated content TVC1 and the second translated content TVC2, respectively. In other words, the first phase and the second phase are performed in parallel. Accordingly, the second speaker 150 outputs the first translated content TVC1 to the target user TU while the first speaker 140 outputs the second translated content TVC2 to the local user LU, ensuring that no sentence is left out or untranslated during the conversation.

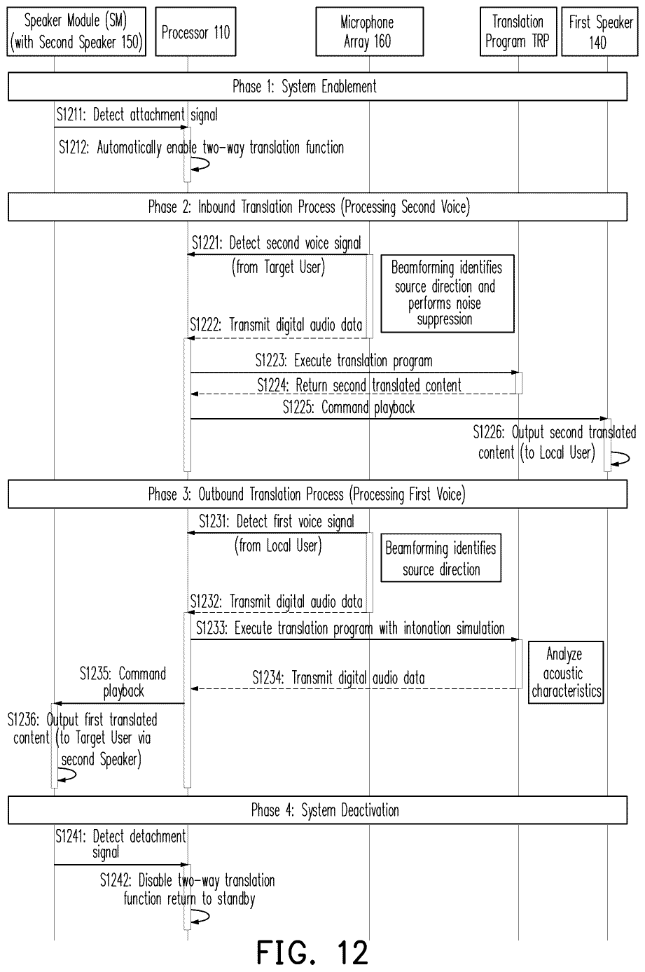

Referring to FIG. 12, in an embodiment, FIG. 12 is a sequence diagram illustrating a two-way language translation method performed by the wearable device 10 with the speaker module 20 (or the attachable speaker module 800 or 900). Compared to FIG. 11, the two-way language translation method shown in FIG. 12 further includes a system enablement phase (Phase 1) and a system deactivation phase (Phase 4) based on an attachment status of the speaker module 20. The translation process in FIG. 12 is divided into four phases: Phase 1 for system enablement, Phase 2 for inbound translation (processing the second voice VC2), Phase 3 for outbound translation (processing the first voice VC1), and Phase 4 for system deactivation.

In Phase 1 (System Enablement), at step S1211, the processor 110 detects an attachment signal from the speaker module 20. The attachment signal indicates that the speaker module 20 is attached to the wearable device 10 via the connector 1010. At step S1212, in response to detecting the attachment signal, the processor 110 automatically enables a two-way translation function of the wearable device 10. When the two-way translation function is enabled, the processor 110 activates the microphone array 160 and prepares the translation program TRP for translation processing.

In Phase 2 (Inbound Translation Process-Processing Second Voice), at step S1221, the microphone array 160 detects a second voice signal from the target user TU. At this step, the processor 110 executes a beamforming algorithm to identify a source direction of the second voice VC2 and performs noise suppression on the second voice VC2. At step S1222, the microphone array 160 transmits digital audio data corresponding to the second voice VC2 to the processor 110. At step S1223, the processor 110 executes the translation program TRP to translate the second voice VC2. At step S1224, the translation program TRP returns the second translated content TVC2 to the processor 110. At step S1225, the processor 110 commands the first speaker 140 to playback the second translated content TVC2. At step S1226, the first speaker 140 outputs the second translated content TVC2 to the local user LU.

In Phase 3 (Outbound Translation Process-Processing First Voice), at step S1231, the microphone array 160 detects a first voice signal from the local user LU. At this step, the processor 110 executes the beamforming algorithm to identify a source direction of the first voice VC1. At step S1232, the microphone array 160 transmits digital audio data corresponding to the first voice VC1 to the processor 110. At step S1233, the processor 110 executes the translation program TRP with an intonation simulation algorithm to translate the first voice VC1. Specifically, the translation program TRP analyzes acoustic characteristics of the first voice VC1, including a voice tone, a pitch variation, and a volume change of the local user LU, and applies the acoustic characteristics to the first translated content TVC1. At step S1234, the translation program TRP returns the first translated content TVC1 to the processor 110. The first translated content TVC1 possesses an intonation of the local user LU. At step S1235, the processor 110 commands the speaker module 20 to playback the first translated content TVC1. At step S1236, the second speaker 150 in the speaker module 20 outputs the first translated content TVC1 to the target user TU.

In Phase 4 (System Deactivation), at step S1241, the processor 110 detects a detachment signal from the speaker module 20. The detachment signal indicates that the speaker module 20 is detached from the wearable device 10. At step S1242, in response to detecting the detachment signal, the processor 110 disables the two-way translation function and returns the wearable device 10 to a standby mode. By automatically enabling and disabling the two-way translation function based on the attachment status of the speaker module 20, the wearable device 10 conserves power and reduces processing load when the two-way translation function is not needed.

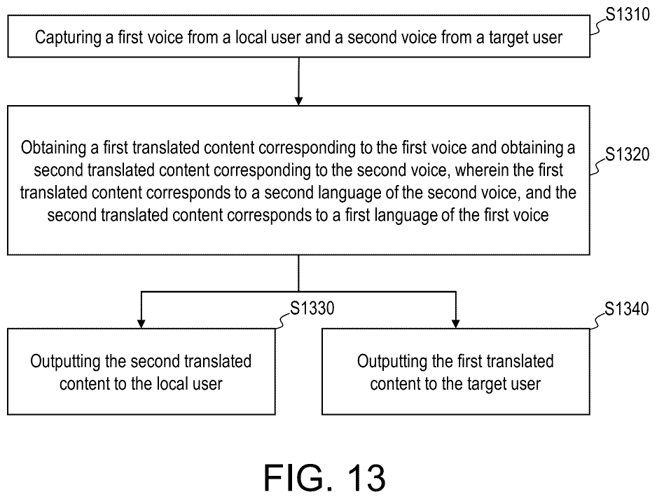

Referring to FIG. 13, in an embodiment, FIG. 13 is a flowchart illustrating a two-way language translation method applied to the wearable device 10. The two-way language translation method includes steps S1310, S1320, S1330, and S1340.

At step S1310, the wearable device 10 captures a first voice VC1 from the local user LU and a second voice VC2 from the target user TU. The first voice VC1 corresponds to a first language, and the second voice VC2 corresponds to a second language different from the first language.

At step S1320, the wearable device 10 obtains a first translated content TVC1 corresponding to the first voice VC1 and obtains a second translated content TVC2 corresponding to the second voice VC2. The first translated content TVC1 corresponds to the second language of the second voice VC2, and the second translated content TVC2 corresponds to the first language of the first voice VC1.

At step S1330, the wearable device 10 outputs the second translated content TVC2 to the local user LU via the first speaker 140. At step S1340, the wearable device 10 outputs the first translated content TVC1 to the target user TU via the second speaker 150 or the speaker module 20. Steps S1330 and S1340 may be performed sequentially or in parallel.

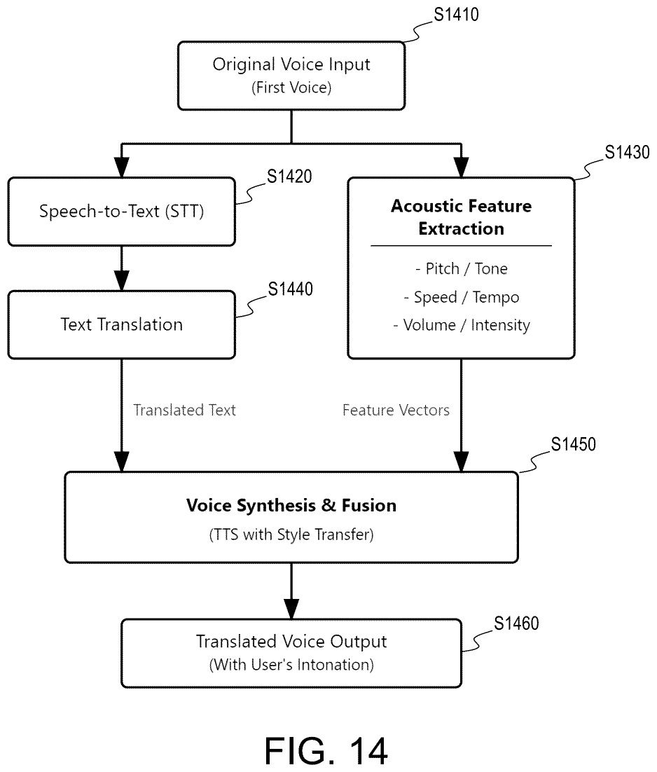

Referring to FIG. 14, in an embodiment, FIG. 14 is a block diagram illustrating an intonation simulation algorithm executed by the processor 110. The intonation simulation algorithm is configured to analyze acoustic characteristics of the first voice VC1 and apply the acoustic characteristics to the first translated content TVC1, such that the first translated content TVC1 possesses an intonation of the local user LU. The intonation simulation algorithm includes steps S1410, S1420, S1430, S1440, S1450, and S1460.

At step S1410, the processor 110 receives an original voice input corresponding to the first voice VC1 from the local user LU. At step S1420, the processor 110 performs a speech-to-text (STT) conversion on the first voice VC1 to obtain a text representation of the first voice VC1 in the first language. At step S1430, in parallel with step S1420, the processor 110 performs an acoustic feature extraction on the first voice VC1. The acoustic feature extraction extracts feature vectors representing acoustic characteristics of the local user LU, including a pitch or tone, a speed or tempo, and a volume or intensity of the first voice VC1.

At step S1440, the processor 110 performs a text translation on the text representation to obtain a translated text in the second language. At step S1450, the processor 110 performs a voice synthesis and fusion operation on the translated text and the feature vectors. Specifically, the processor 110 executes a text-to-speech (TTS) algorithm with style transfer to synthesize a translated voice based on the translated text, and fuses the feature vectors extracted at step S1430 into the translated voice. At step S1460, the processor 110 outputs the first translated content TVC1 as a translated voice output with the intonation of the local user LU. Accordingly, the target user TU receives the first translated content TVC1 that not only conveys the semantic meaning of the first voice VC1 in the second language, but also preserves the speaking style and emotional expression of the local user LU.

In an embodiment, the intonation simulation algorithm is implemented by a pre-trained model based on machine learning algorithms, deep learning algorithms, or an artificial intelligence (AI) model to simulate the intonation of the local user LU. For example, the intonation simulation algorithm may be implemented using a neural network model that has been trained to learn a mapping between input acoustic features and output synthesized speech with style transfer capabilities. During operation, the processor 110 executes inference on the pre-trained model to apply the acoustic characteristics extracted from the first voice VC1 to the synthesized speech of the first translated content TVC1. In some embodiments, the pre-trained model may be further fine-tuned or personalized based on voice samples of the local user LU collected during an initial setup phase, thereby improving the accuracy of the intonation simulation for the local user LU.

In an embodiment, the memory 130 further stores an alignment algorithm. The processor 110 executes the alignment algorithm to synchronize the timing between the translated audio output and the original speech input. Specifically, during real-time translation, there may be temporal misalignment between when a word is spoken and when the corresponding translated word is generated. The alignment algorithm analyzes the temporal boundaries of phonemes, words, and sentences in the first voice VC1 and adjusts the output timing of the first translated content TVC1 to maintain natural conversational rhythm. In some embodiments, when the second translated content TVC2 is output to the local user LU in both audio form and text form, the alignment algorithm synchronizes the text display on the display with the audio playback through the first speaker 140, ensuring that the visual text presentation corresponds temporally to the audio output.

In an embodiment, the audio signal processing and translation functions are jointly implemented by software and firmware. The software is stored in the memory 130 and executed by the main application processor, and the firmware is executed by the embedded processors such as the MCU or DSP. Specifically, the voiceprint main application processor executes high-level operations including natural language processing, machine translation, and text-to-speech synthesis. The embedded processors execute low-level, real-time operations including beamforming, noise suppression, echo cancellation, and audio codec operations. This arrangement of separating software and firmware tasks enables efficient and real-time processing of audio-related digital signal processing (DSP) and algorithmic tasks while reducing power consumption of the wearable device 10.

In summary, the wearable device, the two-way language translation method, and the two-way translation system provided by the present disclosure effectively solve the problem of one-way communication in conventional translation devices. By utilizing the asymmetric dual-speaker architecture, the wearable device enables the local user to hear the translated content of the target user through the first speaker (e.g., rear speaker) and enables the target user to hear the translated content of the local user through the second speaker (e.g., front speaker or attachable speaker module), thereby achieving a seamless two-way conversation without requiring the target user to wear an additional device. Furthermore, the modular design of the attachable speaker module offers flexibility and power efficiency, allowing the user to attach the module only when translation is needed, which automatically triggers the translation function. Moreover, the integration of advanced algorithms, including beamforming, noise suppression, and intonation simulation, ensures that the captured voices are clear and the translated audio output preserves the unique speaking style and emotional context of the user, providing a more natural, accurate, and personalized communication experience.

It will be apparent to those skilled in the art that various modifications and variations can be made to the disclosed embodiments. It is intended that the specification and examples be considered as exemplary only, with a true scope of the disclosure being indicated by the following claims and their equivalents. For example, while the wearable device is described primarily as smart glasses, the concepts of the present disclosure may be applied to other wearable form factors, such as smart headsets, helmets, or ear-mounted devices. The terms “first,” “second,” “third,” etc., are used to distinguish one element from another and do not imply a specific order or priority unless explicitly stated. The term “coupled” may refer to a direct electrical or physical connection or an indirect connection through one or more intermediate components. The functions described as being performed by software or algorithms may be implemented by hardware, firmware, software, or a combination thereof.

What is claimed is:

1. A wearable device for two-way language translation, wherein the wearable device is configured to be worn by a local user, the wearable device comprising:
one or more microphones, configured to capture a first voice from the local user and a second voice from a target user, wherein a language of the first voice is different from a language of the second voice;
a storage device, configured to store a translation program;
a processor, coupled to the one or more microphones and the storage device,
wherein the processor executes the translation program to obtain a first translated content corresponding to the first voice and obtain a second translated content corresponding to the second voice, wherein the first translated content corresponds to the second language of the second voice, and the second translated content corresponds to the first language of the first voice; and
one or more speakers, coupled to the processor, and configured to:
output the second translated content to the local user; and
output the first translated content to the target user.

2. The wearable device of claim 1, wherein the one or more speakers comprise a first speaker and a second speaker, the first speaker is configured to output the second translated content to the local user, and the second speaker is configured to output the first translated content to the target user.

3. The wearable device of claim 2, wherein the first speaker has a first sound outlet facing the local user, and the second speaker has a second sound outlet facing a direction away from the local user.

4. The wearable device of claim 2, wherein the wearable device is smart glasses, and the first speaker is disposed on a temple of the smart glasses.

5. The wearable device of claim 2, wherein the first speaker adopts an open-ear acoustic structure and is configured to generate a directional sound-stage to direct the second translated content to an ear of the local user and suppress sound leakage.

6. The wearable device of claim 2, wherein the first speaker is built into the wearable device, and the second speaker is disposed in a speaker module, wherein the speaker module is detachably coupled to the wearable device.

7. The wearable device of claim 6, wherein the processor is further configured to detect an attachment status of the speaker module, and automatically enable a two-way translation function upon detecting that the speaker module is attached to the wearable device.

8. The wearable device of claim 6, further comprising a connector, wherein the speaker module is electrically coupled to the wearable device via the connector.

9. The wearable device of claim 7, further comprising a magnetic component disposed around the connector or in the speaker module, configured to assist in alignment and attachment of the speaker module to the connector.

10. The wearable device of claim 1, wherein the one or more microphones are microphone arrays comprising a plurality of microphone elements pointing in different directions.

11. The wearable device of claim 10, wherein the storage device further stores a beamforming algorithm, wherein the processor executes the beamforming algorithm to identify source directions of the first voice and the second voice and enhance signal quality of the first voice or the second voice.

12. The wearable device of claim 1, wherein the one or more microphones comprise a first microphone array and a second microphone array, the first microphone array is configured to capture the first voice from the local user, and the second microphone array is configured to capture the second voice from the target user.

13. The wearable device of claim 12, wherein the first microphone array is disposed at a first position on the wearable device closer to a mouth of the local user, and the second microphone array is disposed at a second position on the wearable device farther from the mouth of the local user and facing a forward direction corresponding to an expected position of the target user.

14. The wearable device of claim 1, wherein the storage device further stores an intonation simulation algorithm, wherein the processor executes the intonation simulation algorithm to analyze acoustic characteristics of the first voice and apply the acoustic characteristics to the first translated content, such that the first translated content possesses an intonation of the local user.

15. The wearable device of claim 1, wherein the storage device further stores a language identification algorithm, wherein the processor executes the language identification algorithm to automatically identify language types of the first voice and the second voice.

16. The wearable device of claim 1, further comprising a display coupled to the processor and configured to display the second translated content.

17. The wearable device of claim 1, further comprising a communication interface configured to communicate with an external device; wherein the processor executes the translation program to transmit the first voice and the second voice to the external device for translation processing via the communication interface, and receives the first translated content and the second translated content from the external device.

18. The wearable device of claim 1, wherein the processor is configured to generate the corresponding first translated content or second translated content in real-time while the first voice or the second voice is still in progress.

19. The wearable device of claim 1, wherein the processor is configured to synchronously convert the first voice and the second voice into the first translated content and the second translated content, respectively, when the local user and the target user are speaking simultaneously.

20. The wearable device of claim 1, wherein the storage device further stores voiceprint data of the local user, and the processor utilizes the voiceprint data to distinguish the first voice and the second voice from audio captured by the one or more microphones.

21. The wearable device of claim 20, wherein the processor is further configured to perform a voice separation operation on audio signals captured by the one or more microphones using the voiceprint data, to identify and subtract voice components corresponding to the local user from the audio signals, thereby enhancing signal quality of the second voice from the target user.

22. The wearable device of claim 20, wherein the voiceprint data comprises acoustic characteristics of the local user including at least one of characteristic pitch range, pitch variation patterns, speaking rate, voice timbre, and volume dynamics; wherein the processor executes the intonation simulation algorithm using the voiceprint data to apply the acoustic characteristics to the first translated content.

23. A two-way language translation method applied to a wearable device, wherein the wearable device is configured to be worn by a local user, the method comprising:
capturing a first voice from the local user and a second voice from a target user;
obtaining a first translated content corresponding to the first voice and obtaining a second translated content corresponding to the second voice, wherein the first translated content corresponds to a second language of the second voice, and the second translated content corresponds to a first language of the first voice;
outputting the second translated content to the local user; and
outputting the first translated content to the target user.

24. The method of claim 23, further comprising:
detecting an attachment status of a speaker module; and
automatically enabling a two-way translation function in response to detecting that the speaker module is attached.

25. The method of claim 23, further comprising:
analyzing acoustic characteristics of the first voice; and
applying the acoustic characteristics to the first translated content, such that the first translated content possesses an intonation of the local user.

26. A two-way translation system, comprising:
a wearable device, configured to be worn by a local user;
an external device; and
a communication link established between the wearable device and the external device;
wherein the wearable device captures a first voice from the local user and a second voice from a target user, wherein a language of the first voice is different from a language of the second voice;
wherein the wearable device transmits the first voice and the second voice to the external device via the communication link;
wherein the external device executes a translation program to obtain a first translated content corresponding to the first voice and to obtain a second translated content corresponding to the second voice, wherein the first translated content corresponds to a second language of the second voice, and the second translated content corresponds to a first language of the first voice;
wherein the external device transmits the first translated content and the second translated content to the wearable device via the communication link; and
wherein the wearable device outputs the second translated content to the local user and outputs the first translated content to the target user.

27. A translation device for a wearable device, the translation device comprising:
a housing configured to be detachably coupled to the wearable device;
a connector disposed on the housing, configured to establish an electrical connection with the wearable device for receiving a first voice signal from the wearable device, wherein the first voice signal corresponds to a voice of a local user;
a processor disposed within the housing;
a memory coupled to the processor, wherein the memory stores a translation program; and
a speaker disposed within the housing and coupled to the processor;
wherein the processor executes the translation program to translate the first voice signal and generate a first translated content, and the speaker outputs the first translated content to a target user.

28. The translation device of claim 27, further comprising a microphone array disposed on the housing and configured to capture a second voice from the target user;
wherein the processor executes the translation program to translate the second voice and generate a second translated content; and
wherein the translation device transmits the second translated content to the wearable device via the connector for output to the local user.
